(19) United States
(12) Patent Application Publication
(10) Pub. No.: US 2025/0353203 A1
(43) Pub. Date: Nov. 20, 2025

(54) SYSTEM AND METHOD OF OPTIMIZING WORKPIECE TRIM PRODUCTION AND USE

(71) Applicant: JBT Marel Corporation, Chicago, IL (US)

(72) Inventors: Daniel Holmes, Seattle, WA (US); David Pfanstiel, Canton, GA (US); Dale R. Hunt, Sandusky, OH (US); Richard D. Stockard, San Diego, CA (US)

(73) Assignee: JBT Marel Corporation, Chicago, IL (US)

(21) Appl. No.: 18/665,487

(22) Filed: May 15, 2024

(51) Int. Cl. B26D 5/00; B26D 7/27

(52) U.S. Cl. CPC B26D 5/007; B26D 7/27; B26D 2210/02

(57) ABSTRACT

A trim optimization system may include a first cutting assembly configured to generate workpiece trim and trimmed workpieces, a sensor assembly configured to generate at least one of trimmed workpiece and trim sensor data, and a sorting assembly configured to divert trim from the first cutting assembly to a trim use assembly. The trim optimization system may include memory storing instructions that, when executed by a processor, cause a computing device of the workpiece processing optimization system to: process input data including at least one of trimmed workpiece sensor data, trim sensor data, trim demand for the trim use assembly, workpiece supply data, and workpiece processing requirements; and, output a trim optimization plan including at least one of: a trim designation location in the trim use assembly for an amount of trim; and instructions for adjusting settings to change an amount of workpiece trim generated by the first cutting assembly.

### BACKGROUND

Workpieces, including food products, are often portioned or otherwise cut into smaller pieces by processors in accordance with customer needs. Also, excess fat, bone, and other foreign or undesired materials are routinely trimmed from food products. It is usually highly desirable to portion and/or trim the workpieces into uniform sizes, for example, for steaks to be served at restaurants or chicken fillets used in frozen dinners or in chicken burgers.

Much of the portioning/trimming of workpieces, in particular food products, is now carried out with the use of high-speed processing machines. These machines may use various scanning techniques to ascertain the size, shape, and/or other characteristics of the food product as it is being advanced on a moving conveyor. This information may be analyzed with the aid of a computer to determine how to most efficiently process the food product.

Systems and methods are disclosed herein for optimizing workpiece processing, including optimizing workpiece trim production and use.

### SUMMARY

In some aspects, the techniques described herein relate to a workpiece processing optimization system, including: a first cutting assembly configured to generate workpiece trim and trimmed workpieces; a sensor assembly configured to generate at least one of trimmed workpiece sensor data and trim sensor data; a sorting assembly configured to divert trim from the first cutting assembly to a trim use assembly, the trim use assembly configured to perform at least one of receiving trim and processing trim; a processor; and a memory storing instructions that, when executed by the processor, cause a computing device of the workpiece processing optimization system to: process input data including at least one of trimmed workpiece sensor data, trim sensor data, trim demand for the trim use assembly, workpiece supply data, and workpiece processing requirements; and output a trim optimization plan including at least one of: a trim designation location in the trim use assembly for an amount of trim; instructions for adjusting settings of the first cutting assembly to change an amount of workpiece trim generated by the first cutting assembly.

In some aspects, the techniques described herein relate to a workpiece processing system, including: a portion of a sensor assembly configured to generate incoming workpiece sensor data; a first cutting assembly configured to generate an amount of workpiece trim and trimmed workpieces; a portion of a sorting assembly configured to divert incoming workpieces having a first physical characteristic to a first portion of the first cutting assembly and workpieces having a second physical characteristic to a second portion of the first cutting assembly to generate at least one of a target amount of trim and a target size of trimmed workpieces from each of the first and second portions of the first cutting assembly; a portion of the sensor assembly configured to generate at least one of trimmed workpiece sensor data and trim sensor data; a portion of the sorting assembly configured to divert trim from the first cutting assembly to a trim use assembly, the trim use assembly configured to perform at least one of receiving trim and processing trim; and a first portion of a secondary processing assembly configured to perform at least one secondary processing step on the trimmed workpieces, including at least one of portioning the trimmed workpieces, sorting the trimmed workpieces, packaging the trimmed workpieces, slicing the trimmed workpieces, breading the trimmed workpieces, and thermally processing the trimmed workpieces; and a movement assembly configured to move workpieces.

In some aspects, the techniques described herein relate to a method of optimizing trim for a workpiece processing system, including: cutting, with a first cutting assembly, incoming workpieces to generate an amount of workpiece trim and trimmed workpieces; capturing, with a sensor assembly, sensor data of at least one of incoming workpieces, trimmed workpieces, and trim; diverting, with a sorting assembly, trim from the first cutting assembly to a trim use assembly; at least one of receiving trim and processing trim at the trim use assembly; processing, with a computing device, input data including at least one of incoming workpieces, trimmed workpiece sensor data, trim sensor data, trim demand for the trim use assembly, and workpiece processing requirements; and outputting, with a computing device, a trim optimization plan including at least one of: a trim designation location in the trim use assembly for an amount of trim; and instructions for adjusting settings of the first cutting assembly to change the amount of workpiece trim generated by the first cutting assembly.

In some aspects, the techniques described herein relate to a method of treating workpieces with a treatment solution, including: cutting, with a first cutting assembly, incoming workpieces to generate an amount of workpiece trim and trimmed workpieces; capturing, with a sensor assembly, sensor data of at least one of incoming workpieces, trimmed workpieces, and trim; processing, with a computing device, input data including at least one of incoming workpiece data, workpiece supply data, trimmed workpiece sensor data, trim sensor data, trim demand for producing a treatment solution using the workpiece trim, and workpiece processing requirements; outputting, with a computing device, a trim optimization plan including instructions for adjusting settings of the first cutting assembly to change the amount of workpiece trim generated by the first cutting assembly; diverting, with a sorting assembly, trim from the first cutting assembly to a treatment solution assembly; producing a treatment solution using the workpiece trim; and applying the treatment solution to trimmed workpieces.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 shows a block diagram of a non-limiting example of a workpiece processing optimization system according to various aspects of the present disclosure.

FIG. 2 shows a schematic of a non-limiting example of the workpiece processing optimization system of FIG. 1.

FIG. 3A shows an isometric view of an exemplary slicer assembly according to various aspects of the present disclosure.

FIG. 3B shows a front isometric view of an exemplary slicer assembly according to various aspects of the present disclosure.

FIG. 3C shows a rear isometric view of the slicer assembly of FIG. 3B.

FIG. 3D shows an isometric view of an exemplary portioner assembly according to various aspects of the present disclosure.

FIG. 4A shows an elevational view of an exemplary treatment solution assembly according to various aspects of the present disclosure.

FIG. 4B shows an exemplary top port needle carrier used to carry injection needles for injecting brine at a treatment solution assembly.

FIG. 4C-4E show an exemplary top port manifold for use with the exemplary top port needle carrier of FIG. 4B.

FIG. 4F shows an elevational view of an exemplary injection needle for use with the exemplary needle carrier of FIG. 4B.

FIG. 4G shows a cross-sectional view of the exemplary injection needle of FIG. 4F.

FIG. 5A shows an isometric view of an exemplary portioner assembly according to various aspects of the present disclosure.

FIG. 5B shows an isometric view of an exemplary portioner assembly and harvester assembly according to various aspects of the present disclosure.

FIG. 6 shows an elevational view of an exemplary sorting assembly according to various aspects of the present disclosure.

FIG. 7 shows a first exemplary layout and workpiece flow path for a workpiece processing system according to various aspects of the present disclosure.

FIG. 8 shows a second exemplary layout and workpiece flow path for a workpiece processing system according to various aspects of the present disclosure.

FIG. 9 shows a third exemplary layout and workpiece flow path for a workpiece processing system according to various aspects of the present disclosure.

FIG. 10 is a block diagram of a non-limiting example of a processing computing device according to various aspects of the present disclosure.

FIG. 11 is a block diagram of a non-limiting example of a trim optimization computing device according to various aspects of the present disclosure.

FIG. 12 is a flowchart of a non-limiting example of a method of managing aspects of workpiece processing, including optimizing trim production and use.

FIG. 13 is a flowchart of a non-limiting example of a method of treating workpieces with a treatment solution

FIG. 14 is a block diagram that illustrates a non-limiting example of a computing device appropriate for use as a computing device with examples of the present disclosure.

### DETAILED DESCRIPTION

As noted above, workpieces, including food products, are often portioned or otherwise cut into smaller pieces by processors in accordance with customer needs. Also, excess fat, bone, and other foreign or undesired materials are routinely trimmed from food products. Moreover, much of the cutting/portioning/trimming of workpieces, in particular food products, is now carried out with the use of high-speed processing machines, such as portioners and slicers. These machines may use various scanning techniques to ascertain the size and shape of the workpiece as it is being advanced on a moving conveyor. This information may be analyzed with the aid of a computer to determine how to efficiently process the workpiece, such as how to portion and/or slice the workpiece into smaller pieces of optimum sizes.

The processed workpiece, after being sliced, portioned, trimmed, etc., may be designed for a particular end use or for further processing. For example, a chicken breast fillet may be sliced/portioned into at least two end products, such as sandwich portions, chicken strips, chicken nuggets, etc. Each of the different end products may be designated for a particular use or further process, such as batter/breading, frying, cooking, freezing, packaging, etc.

As noted above, excess fat, bone, and other foreign or undesired materials are routinely trimmed from the workpieces during processing. In many instances, it is desirable to minimize the amount of trim produced during processing, thereby maximizing the size and/or quantity of end products that can be produced from a workpiece, and/or minimizing waste. In some instances, a certain amount of trim is desired as an end product and/or for processing workpieces. For instance, chicken breast butterfly or fillet trim may be designated and sold for use in nugget generation (e.g., nuggets formed from ground trim). In other instances, workpiece trim can be emulsified and used to formulate a workpiece treatment solution, such as a brine, a marinade, pickling, etc.

Aspects of the present disclosure are directed to systems and methods of optimizing workpiece processing, including optimizing workpiece trim production and use. Workpiece processing may include slicing, treating with a treatment solution (e.g., brine, marination, pickle, etc.), portioning, cutting, sorting, harvesting, packaging, etc. Aspects of the present disclosure are also directed to systems and methods of preparing a treatment solution using workpiece trim and treating workpieces with the treatment solution. Further aspects of the systems and methods disclosed herein will also become apparent from the descriptions and illustrations provided herein.

In the present disclosure, references to “food,” “food products,” “food pieces,” “food items,” “pieces,” “portions,” etc., are used interchangeably and are meant to include all manner of foods. Such foods may include meat, fish, poultry, plant-based products, fruits, vegetables, nuts, or other types of foods. Also, the automated line loading system and method disclosed herein is directed to raw food products, as well as partially and/or fully processed or cooked food products.

Further, automated line loading systems and methods disclosed herein, though sometimes described with specific applicability to food products or food items, may also be used outside of the food area. Accordingly, the present disclosure may reference “workpieces,” “products”, “components”, “samples”, etc., which terms are synonymous with each other. It is to be understood that references to “workpieces,” “products”, “components”, “samples”, etc., also include food, food products, food pieces, food items, etc. Moreover, references to “food”, “food products”, “food pieces”, “food items”, “pieces”, “portions”, etc., also include “workpieces,” “products”, “components”, “samples”, etc.

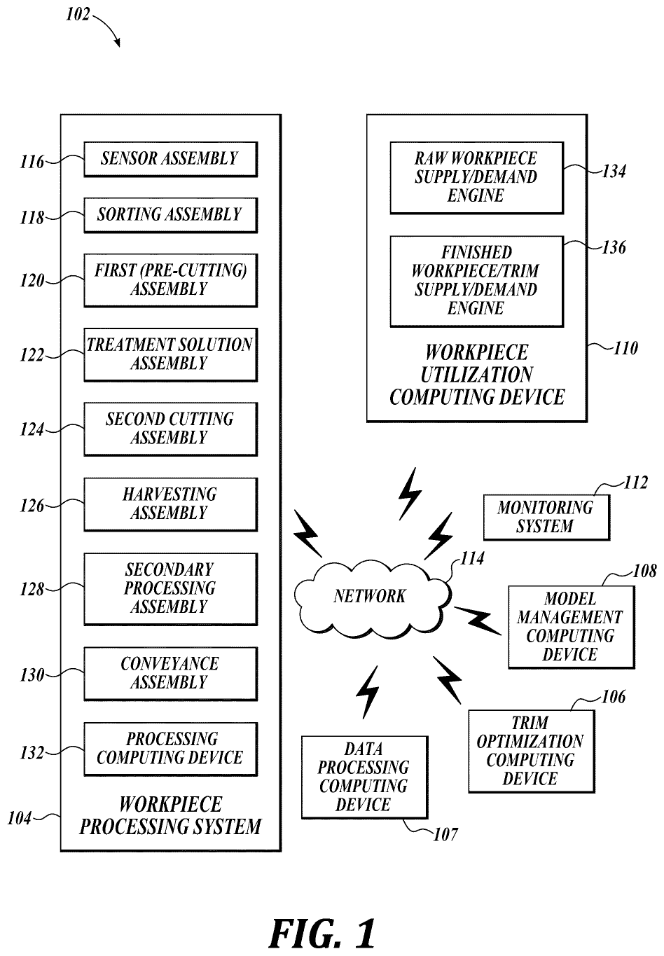

FIG. 1 depicts a block diagram of a non-limiting example of a workpiece processing optimization system 102 that can be used to manage workpiece processing optimization, including optimizing workpiece trim production and use. The workpiece processing optimization system 102 may include various components and networked computing devices configured for managing aspects of workpiece processing optimization, such as a workpiece processing system 104, a trim optimization computing device 106, a data processing computing device 107, a model management computing device 108, a workpiece utilization computing device 110, and a monitoring system 112 communicatively coupled together through a network 114. The network 114 can be any kind of network capable of enabling communication between the various components of the workpiece processing optimization system 102. For example, the network can be a WiFi network.

A general overview of the components of the workpiece processing optimization system 102 will first be provided. As noted above, the workpiece processing optimization system 102 is generally configured to carry out and manage aspects of workpiece processing, including optimizing workpiece trim production and use. The workpiece processing system 104 of the workpiece processing optimization system 102 may be generally configured to carry out at least some of the workpiece processing steps, such as sorting, slicing, treating, cutting (e.g., portioning, trimming, etc.), harvesting, packaging, etc. For instance, the workpiece processing system 104 may be configured to receive chicken breast butterflies or fillets from an infeed system and perform any necessary steps for producing desired end products from the chicken breast butterflies or fillets, such as fillets, sandwich portions, nuggets, etc.

The trim optimization computing device 106 may be generally configured to manage workpiece trim production and trim end use designation. Workpiece trim may be generated during one or more steps of workpiece processing, such as during slicing or portioning. The trim optimization computing device 106 may use information regarding workpiece supply, finished workpiece demand, workpiece processing requirements, trim demand (e.g., trim required to make treatment solution, trim needed as an end product, etc.), and the amount of trim produced (e.g., weight data) to optimize the production of trim and use of trim.

The model management computing device 108 may be generally configured to train one or more machine learning models for use in the workpiece processing optimization system 102. In that regard, the model management computing device 108 may receive or request workpiece and/or trim sensor data generated by the workpiece processing system 104 and/or the data processing computing device 107, trim optimization data generated by the trim optimization computing device 106, or any other data for use in training machine learning models. The one or more machine learning models may be configured to output a trim optimization plan using one or more of information regarding workpiece and/or trim sensor data, workpiece supply, finished workpiece demand, workpiece processing requirements, and trim demand as input. The one or more machine learning models may be carried out by the trim optimization computing device 106 and/or another computing device, such as the data processing computing device 107.

The workpiece utilization computing device 110 may be generally configured to curate and provide information regarding workpiece supply, finished workpiece demand, and trim demand to one or more other components, such as the workpiece processing system 104 and/or the trim optimization computing device 106. The workpiece processing system 104 and/or the trim optimization computing device 106 may use the information regarding workpiece and trim supply and demand to optimize one or more aspects of workpiece processing. As a specific example, a slicer of the workpiece processing system 104 may be adjusted based on data sent from the workpiece utilization computing device 110 regarding finished workpiece supply/demand requirements and/or trim requirements.

The monitoring system 112 may be generally configured to curate and provide information regarding the workpiece processing optimization system 102, such as the realization of workpiece trim optimization. The information may be used to monitor and control aspects of the workpiece processing optimization system 102, such as identifying any areas of concern, finding trends, assessing settings, etc.

It should be appreciated that any of the techniques described herein may be carried out by any suitable computing device(s) and should not be limited to the specific configurations provided herein. For instance, some or all of the techniques described herein may be carried out by the processing computing device 132, or some or all of the techniques described herein may be carried out by the data processing computing device 107 or trim optimization computing device 106. Thus, the examples and techniques discussed herein should not be seen as limiting.

Detailed exemplary aspects of the workpiece processing system 104 will now be described. The processing system 104 is generally configured to carry out processing of workpieces in a manner that supports production of a desired end product(s) and optimized trim production and/or use. Any suitable assemblies and components, including the arrangement of assemblies and components, may be used. For instance, the processing system 104 may incorporate aspects of the systems shown and described in U.S. Pat. No. 7,651,388, entitled “Portioning apparatus and method”, U.S. Pat. No. 7,672,752, entitled “Sorting workpieces to be portioned into various end products to optimally meet overall production goals”, and U.S. Pat. No. 8,688,267, entitled “Classifying workpieces to be portioned into various end products to optimally meet overall production goals”, hereby incorporated by reference herein in their entirety.

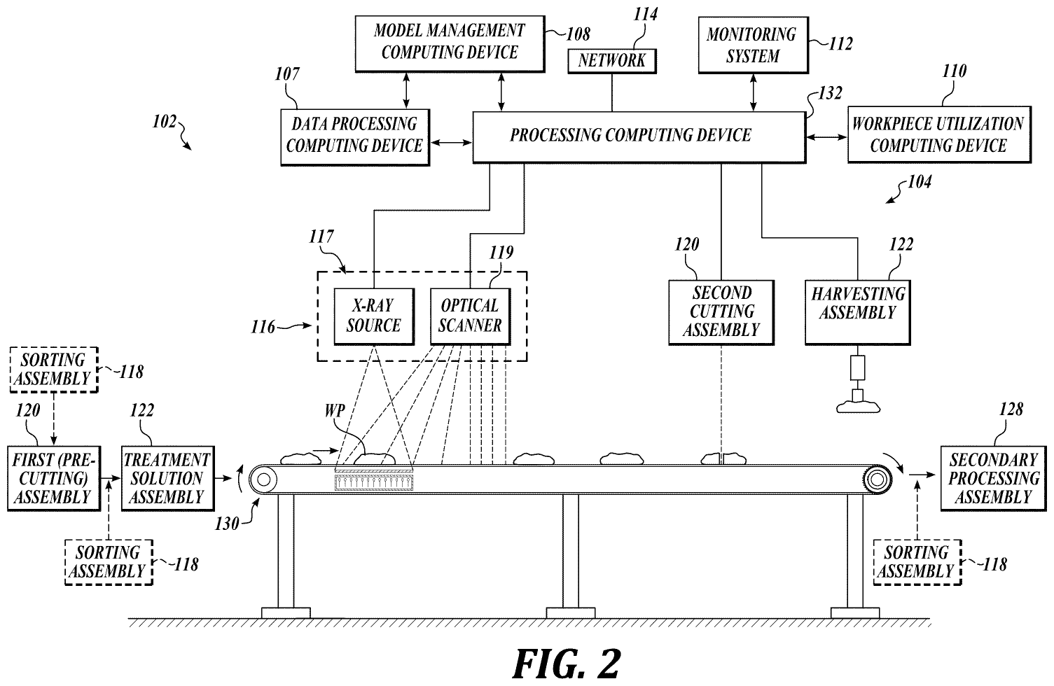

In the depicted exemplary block diagram of FIG. 1, the workpiece processing system 104 includes a sensor assembly 116, a sorting assembly 118, a pre-cutting or first assembly 120, a trim use assembly including a trim secondary processing subassembly and a treatment solution subassembly 122 (herein sometimes simply “treatment solution assembly 122”), a second cutting assembly 124, a harvesting assembly 126, a secondary processing assembly 128 (a portion of which may define the trim secondary processing subassembly), and a conveyance assembly 130. The various components of the workpiece processing system 104 may be controlled by a processing computing device 132. Detailed exemplary aspects of the components of the workpiece processing system 104 will now be described with additional reference to FIG. 2, which depicts an exemplary schematic illustration of the workpiece processing optimization system 102 having the various components shown in FIG. 1.

The conveyance assembly 130 is configured to carry workpieces between various portions of the workpiece processing system 104. For instance, the conveyance assembly 130 may carry workpieces between one or more of the sensor assembly 116, the sorting assembly 118, the first cutting assembly 120, the treatment solution assembly 122, the second cutting assembly 124, the harvesting assembly 126, and the secondary processing assembly 128. The conveyance assembly 130 may include one or more endless conveyors arranged in series and/or in parallel and/or or another movement device.

The sensor assembly 116 is configured to capture sensor data pertaining to workpieces and/or trim. In that regard, the sensor assembly 116 may include one or more sensors configured to capture data of the workpieces and/or trim, such as when they are moved by the conveyance assembly 130. In some examples, the sensor assembly 116 includes a vision system configured to capture image sensor data and an optional weight station configured to capture weight sensor data of the workpieces and/or trim as they are moved by the conveyance assembly 130.

The vision system may include any suitable image sensors configured to capture image data of the moving workpieces/trim for assessing physical characteristics of the workpieces/trim (herein sometimes simply “workpiece”). For instance, one or more of the scanners and/or systems and methods for processing scanner data described in U.S. Pat. No. 10,721,947, entitled “Apparatus for acquiring and analysing product-specific data for products of the food processing industry as well as a system comprising such an apparatus and a method for processing products of the food processing industry,” hereby incorporated by reference herein in its entirety, may be used.

In the depicted example, the sensor assembly 116 may utilize an x-ray apparatus 117 for capturing image data determining the physical characteristics of the workpiece, including its shape, mass, and weight. X-rays may be passed through the object in the direction of an x-ray detector (not labeled). Such x-rays are attenuated by the workpiece in proportion to the mass thereof. The x-ray detector is capable of measuring the intensity of the x-rays received thereby, after passing through the workpiece.

The x-ray image data may be utilized to determine physical parameters pertaining to the size and/or shape of the workpiece, including for example, the length, width, aspect ratio, thickness, thickness profile, contour, outer contour configuration, perimeter, outer perimeter configuration, outer perimeter size and/or shape, volume, weight, as well as other aspects of the physical parameters/characteristics of the workpiece. With respect to the outer perimeter configuration of the workpiece, the X-ray detector can determine locations along the outer perimeter of the workpiece based on an X-Y coordinate system or other coordinate system. An example of such x ray scanning devices are disclosed in U.S. Pat. No. 5,585,605, entitled “Optical-scanning system employing laser and laser safety control”, U.S. Pat. No. 10,654,185, entitled “Cutting/portioning using combined X-ray and optical scanning”, U.S. Pat. No. 5,585,603, entitled “Method and system for weighing objects using X-rays”, as well as U.S. Pat. No. 10,721,947 (referenced above), incorporated herein by reference in their entirety.

The vision system may also include an optical scanner 119 for generating at least one of a visible light (e.g., greyscale) image, a laser light scattering image, a height map, a hyperspectral image, a multispectral image, etc., of the workpieces/trim to show one or more of the overall shape/size of the workpieces/trim, a height or thickness over the area of the workpieces/trim, etc. Scanning with an optical scanner can be carried out using a variety of techniques, such as the techniques shown and described in U.S. Pat. Nos. 10,654,185 and 10,721,947, referenced above and incorporated herein.

The optical scanner 119 may include a video camera to view workpiece illuminated by one or more light sources. In one example, light from the light source is extended across the moving conveyor belt to define a sharp shadow or light stripe line, with the area forwardly of the transverse beam being dark. When no workpiece are being carried by the conveyor belt, the shadow line/light stripe forms a straight line across the belt. However, when a workpiece/trim passes across the shadow line/light stripe, the upper, irregular surface of the workpiece/trim produces an irregular shadow line/light stripe as viewed by a video camera directed diagonally downwardly on the workpiece/trim and the shadow line/light stripe. The video camera detects the displacement of the shadow line/light stripe from the position it would occupy if no workpiece were present on the conveyor belt. This displacement represents the thickness of the workpiece/trim along the shadow line/light stripe. The length of the workpiece/trim is determined by the distance of the belt travel that shadow line/light stripes are created by the workpiece/trim.

A conveyor belt of the conveyance assembly 130 may be a flat, solid (typically flat, non-metallic) belt to support the workpiece during scanning. Moreover, an encoder may be used to track belt movement for accurately capturing image data relative to sweep distance of the laser line. A scan area may be defined along a length and width of the belt for capturing relevant time-stamped workpiece/trim scan data while excluding (e.g., blobbing out) any irrelevant workpiece/trim scan data.

In some examples, the optical scanner 119 is a single SICK® camera with a single laser light source that is suitable for capturing optical data and generating two or more images/views based on the optical data. The vision system may also include image sensor technology suitable for capturing image data needed to generate 3D models of the workpiece and/or a 2D representation of the height or elevation of the scene. In some examples, the sensor assembly 116 includes at least one of a 3D vision system or 3D laser scanning technology like LiDAR (Light Detection and Ranging), structured light scanning, or photogrammetry, or combinations thereof. In some examples, the sensor assembly 116 includes a structured light source and scanner configured to capture workpiece/trim depth and surface information for generating a height map or 3D model of the workpiece/trim and/or a 2D representation of the height or elevation of the scene (sometimes also referred to herein as a “3D laser scanner” or the like).

In some examples at least two optical cameras each equipped with a different imaging processor are used. For example, a simple optical camera, for example a greyscale camera, and/or RGB camera and/or IR and/or UV camera and/or a charge coupled device (CCD) and/or a Time-of-Flight (ToF) stereoscopic camera, a stereo camera, a lidar sensor, a structured light sensor, or the like, or combinations thereof, can be used to acquire and/or generate one or more complete images of the workpiece for detecting certain characteristics, such as, e.g., the outer contour of the workpiece. Moreover, a second, special camera, for example a multispectral or hyperspectral camera, can be used to acquire images/data of specific regions or characteristics of the workpiece, such as blood spots, streaks of fat or the like. It should be appreciated that a single camera/scanner may instead be used to capture all the data needed to generate the various images, such as with various imaging processes.

If separate conveyors are used for x-ray and optical scanning, the processing computing device 132 may analyze data from the X-ray apparatus 117 and the optical scanner 119 to confirm that the workpiece scanned by the optical scanner is the same as the workpiece previously scanned by X-ray apparatus and/or whether the workpiece has moved or shifted during transfer between conveyors. Such confirmation may be done, for instance, before the processing computing device 132 processes results of the optical scanning occurring at sensor assembly 116. Although any suitable method may be used for confirming that the workpiece scanned by the optical scanner is the same as the workpiece previously scanned by X-ray apparatus, in some examples, the method used is substantially similar to that discussed in U.S. Pat. Nos. 10,654,185 and 10,721,947 (referenced above), incorporated by reference herein.

A second optical scanner (not shown) may be located upstream of a first optical scanner for use in capturing optical image(s)/data before the workpiece is transferred from a first (scanning) conveyor to a second (portioning) conveyor. For instance, the second optical scanner may be used to scan the workpiece when located on a first conveyor, such as described in U.S. patent application Ser. No. 16/887,057, entitled “Determining the Thickness Profile of Work Products”, hereby incorporated by reference in its entirety. The optical image(s)/data captured by the downstream optical scanner can be used to generate images for detecting the existence of certain visual characteristics, for confirming that the workpiece scanned by the downstream optical scanner is the same as the workpiece previously scanned at the upstream optical scanner and/or whether the workpiece has moved or shifted during transfer between conveyors, as discussed above.

The sensor assembly 116 may include one or more additional optical scanners or other image sensors at various points in the workpiece flow path of the workpiece processing system 104. For instance, one or more optical scanners may be associated with one or more sorting assemblies 118, the first cutting assembly 120, and any secondary processing assemblies 128.

In some examples, the sensor assembly may include a weigh station configured to capture a weight of the workpieces and/or trim as they are moved by the conveyance assembly 130. For instance, the conveyance assembly 130 may incorporate a weigh deck or another weight measurement device to capture a weight measurement of workpiece(s) and/or trim for a certain belt span length, at a certain time, etc. In some examples, the optional weight station is used to estimate a weight measurement of a workpiece(s) and/or trim by detecting a vertical displacement of the conveyor belt and associating that vertical displacement with a weight. For instance, the conveyor belt may sag under the weight of the workpiece(s) and/or trim, and the sag of the belt captured in image data can be measured. In some examples, the conveyance assembly 130 can be supported on high precision springs that allow vertical displacement of the conveyance assembly 130 for measurement.

Weight measurements of the workpieces and/or trim may be used to verify whether the processing computing device 132 is correctly predicting and/or determining a weight of the workpieces and/or trim. For instance, a vision system of the sensor assembly 116 may be used to calculate/predict a weight of a sliced (and/or portioned) workpiece and the trim that is sliced from the workpiece using image data and a known density of the workpiece. Such calculated/predicted weights can be verified by a weigh station located downstream of the first cutting assembly 120. If a discrepancy exists between the actual and calculated/predicted weights, the processing computing device 132 or another computing device may output instructions for adjusting the first cutting assembly 120 to cut or slice differently for achieving target workpiece and/or trim weights.

In some examples, the weigh station may be configured to determine a weight of an aggregated supply of trim generated by the first cutting assembly 120. For instance, the weigh station may be incorporated into the trim use assembly for weighing (and thereafter optionally diverting with a sorter) the trim introduced into various portions of the trim use assembly. For instance, a weigh station may be used to weight (and optionally divert) trim into a brine preparation station of the trim use assembly. Typically, treatment solutions are prepared in batches, where the various ingredients are measured out and added into a mixer, such as an emulsifier. In that regard, the weigh station may be configured as a load cell or similar that configured to weigh a batch supply of trim for use at the brine preparation station.

Weight data from the weigh station may be sent to the processing computing device 132 for each batch weighed for an entire production shift. The batches may be correlated to first cutting assembly 120 cutter configurations, sorting assembly configurations, incoming workpiece specifications, etc., to correlate the amount of trim generated by the first cutting assembly 120 to various settings of the workpiece processing optimization system 102. For instance, a first batch trim weight may be correlated to a first slicer setting and a workpiece having a first weight or thickness, and a second batch trim weight may be correlated to the first slicer setting and a workpiece having a second weight or thickness. The weight data from the weigh station may be sent to the processing computing device 132 for an entire production shift to determine the amount of trim generated through the shift and the total amount of trim generated for the shift.

The sensor assembly 116 may also include any other suitable sensors for capturing data pertaining to the workpieces. For instance, the sensor assembly 116 may also include one or more of a temperature sensor (e.g., thermal imaging cameras, infrared thermometers, thermocouples, resistance thermometers such as Resistance Temperature Detectors (RTDs), etc.), a stereo and color camera, such as for capturing still images (e.g., Intel RealSense D405), microphones, an optical encoder assembly, etc.

In some examples, the sensor assembly 116 may include a temperature sensor system configured to capture and monitor a temperature of the trim and/or workpieces before, during, and/or after use or treatment at the treatment solution assembly 122. Typically, a temperature of the treatment solution (e.g., brine) and/or a temperature of the workpieces to be treated within the treatment solution are brought to a treatment temperature and substantially maintained at that treatment temperature for treatment. For instance, a treatment solution and workpiece may be brought to a sufficiently low, food safe treatment temperature configured to prevent bacteria growth in the workpiece between treatment and prior to secondary processing, such as cooking or freezing.

In any event, the sensor assembly 116 used in the systems and methods described herein excludes any type of scanning that could be done by human observation, which would not support the needed processing speed and accuracy of the workpiece processing optimization system 102.

Sensor data captured by the sensor assembly 116 may be transmitted to one or more of the processing computing device 132, the trim optimization computing device 106, the model management computing device 108, the workpiece utilization computing device 110, and the monitoring system 112. For instance, the sensor data captured by the sensor assembly 116 may be transmitted to the processing computing device 132, which may process the sensor data (e.g., format the data, generate 2D or 3D models with the data, etc.) for use in workpiece process management and/or for sending to another computing device, such as the trim optimization computing device 106, the data processing computing device 107, the model management computing device 108, the workpiece utilization computing device 110, and the monitoring system 112.

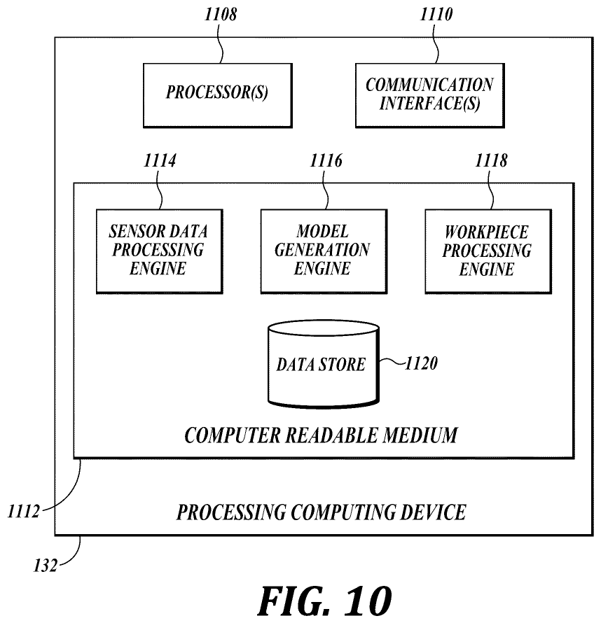

The processing computing device 132 may include circuitry for executing one or more feature recognition modules in a sensor data processing engine 1114 (see FIG. 10) for generating views/images from the scan data and/or processing data from the different views. For instance, the sensor data processing engine 1114 of the processing computing device 132 may be configured to generate at least one of a fat recognition (FRS) object view, a laser scatter object view, and a height mode object view of a food product, such as from data captured with an optical scanner.

The processing computing device 132 may instruct the sorting assembly 118 and/or the harvesting assembly 126 to divert workpieces and/or trim based on various physical parameters of the workpiece, such as determined from the sensor data. The processing computing device 132 may also instruct the first cutting assembly 120 and/or the second cutting assembly 124 to perform one or more of cutting, portioning, and trimming a workpiece in accordance with customer specifications based on various physical parameters of the workpiece determined from the sensor data. Such parameters/characteristics may include, for example, size, shape, and/or height of the workpieces. For instance, sensors may be used to gather data regarding a length, width, length/width aspect ratio, thickness, thickness profile, contour, outer contour configuration, outer taper, flatness, outer perimeter configuration, outer perimeter size and shape, volume, weight, as well as whether the workpieces contain any undesirable materials, such as bones, fat, cartilage, metal, glass, plastic, etc., and the location of the undesirable materials in the workpieces. With respect to the thickness profile of the workpiece, such profile can be along the length of the workpiece, across the width of the workpiece, as well as both across/along the width and length of the workpiece.

The parameter referred to as the “perimeter” of the workpiece refers to the boundary or distance around a workpiece. Thus, the terms outer perimeter, outer perimeter configuration, outer perimeter size, and outer perimeter shape pertain to the distance around, the configuration, the size and the shape of the outermost boundary or edge of the workpiece.

The foregoing enumerated size and/or shape parameters/characteristics are not intended to be limiting or inclusive. Data regarding other size and/or shape parameters/characteristics may be ascertained by any component(s) of the sensor assembly 116 and used with the present systems and methods for processing the workpieces. Moreover, the definitions or explanations of the above specific size and/or shape parameters/characteristics discussed above are not meant to be limiting or inclusive.

Exemplary aspects of the sorting assembly 118 will now be described. In general, the sorting assembly 118 is configured to sort or divert workpieces and/or trim before, during, and/or after workpiece processing, such as cutting, trimming, portioning, etc. Sorting may be carried out, for instance, to direct a workpiece and/or trim to a location suitable for an intended use or next step(s) of the workpieces and/or trim. In some examples, the workpieces and/or trim are sorted into one of multiple primary processing conveyor lanes, one of multiple secondary processing conveyor lanes, chutes, collection bins/totes/buckets, etc. The selected location for the sorted workpiece may depend on the workpiece and/or trim characteristics relative to a specific sorting task.

In that regard, multiple sorting assemblies may be used for carrying out sorting or diverting tasks at various locations in the workpiece processing system 104 (sometimes referenced as a first sorting assembly 118a, a second sorting assembly 118b, . . . , and an nth sorting assembly 118n). For example, if a first sorting assembly 118s is located at a beginning, upstream end of the workpiece processing system 104, the first sorting assembly 118a may be used to sort randomly sized incoming workpieces (e.g., chicken breast butterflies or fillets) into multiple infeed conveyor lanes for producing different types of end products (e.g., sandwich portions, chicken strips, chicken nuggets, etc.) and/or a suitable type or volume of trim. The infeed conveyor lanes may feed into the first cutting assembly 120 configured to cut workpieces in multiple lanes according to different specifications.

A second sorting assembly 118b may be located downstream of the first sorting assembly 118a to sort workpieces and/or trim after passing through the first cutting assembly 120, as shown in FIG. 2. For instance, the second sorting assembly 118b may divert trim to the trim use assembly, such as a first portion of the treatment solution assembly 122 for use in producing marinate. The second sorting assembly 118b may divert sliced or cut workpieces from the first cutting assembly 120 to a second portion of the treatment solution assembly 122 to be marinated. The second sorting assembly 118b may also divert any excess trim not needed for the treatment solution assembly 122 to the secondary processing assembly 128 (or the secondary processing subassembly of the trim use assembly, not separately shown), such as a collection bin, a packager, etc.

A third sorting assembly 118c may be located downstream of the second sorting assembly 118b to sort workpieces and/or trim after passing through various processing components of the workpiece processing system 104, such as the second cutting assembly 124. The third sorting assembly 118c may be used to sort portioned workpieces and/or trim resulting from the portioned workpieces. For instance, the third sorting assembly 118c may divert trim to a portion of the secondary processing assembly 128 (collection tote/bin/bucket, etc.) for use in secondary processing. The third sorting assembly 118c may also divert portioned/trimmed/cut workpieces to a portion of the secondary processing assembly 128, such as for slicing, breading, cooking, packaging, freezing, etc. In some examples, the third sorting assembly 118c may be configured to divert a first type of workpiece to a first type of secondary processing (e.g., breading) and a second type of workpiece to a second type of secondary processing (e.g., packaging).

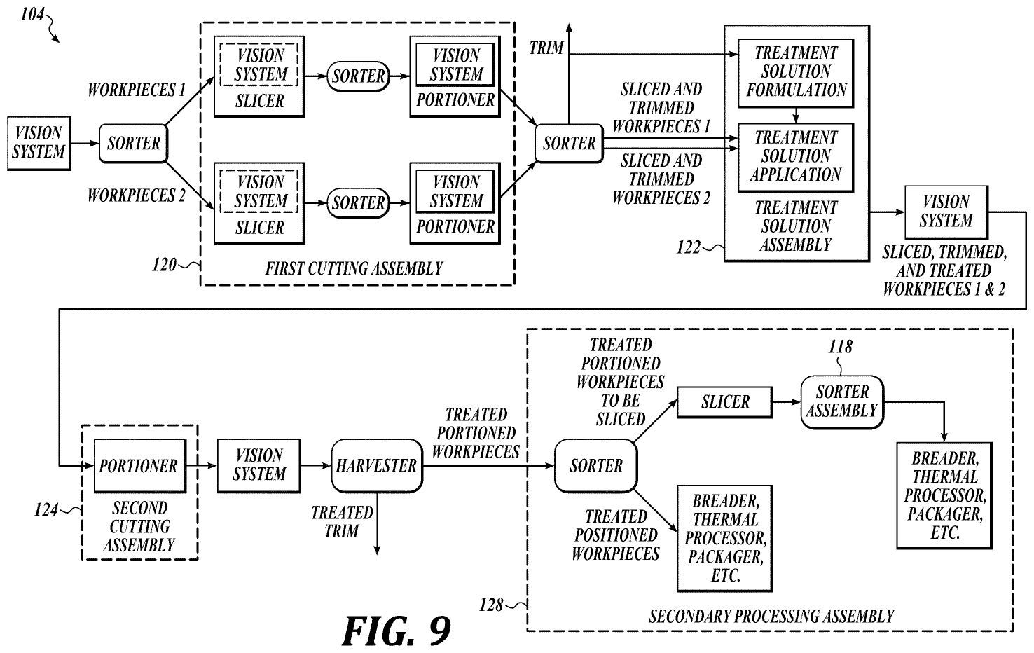

The sorting assembly 118 may include any suitable mechanical structure to sort workpieces and/or trim, such as when workpieces and/or trim are being moved by the conveyance assembly 130. For instance, the sorting assembly 118 may include air sorters, lane dividers, paddles, drop-down conveyors, a pick-up assembly, suction nozzles, a bellows device (see FIG. 9), a prime mover array (such as that shown and described in U.S. Provisional Patent Application No. 63/571,910 entitled “Aggregated to Organized Automated Line Loading System and Method”, incorporated by reference in its entirety herein), etc.

Any controllable components of the sorting assembly 118 may be controlled by the processing computing device 132, such as in response to processed sensor data of the sensor assembly 116. For instance, workpiece and/or trim sensor data may be compared to workpiece specifications and/or trim requirements for the specific sorting task. Based on a comparison of the sensor data to workpiece specifications and/or trim requirements, the workpiece and/or trim pertaining to the sensor data may be sorted to a designated location. For instance, each of the incoming workpieces may be sorted by the first sorting assembly 118a to an appropriate lane or location of the first cutting assembly 120 for slicing the workpiece to produce an optimal end product based on a size (e.g., length, height, weight) of the workpiece.

Exemplary aspects of the first cutting assembly 120 will now be described. The first cutting assembly 120 may be generally configured to perform a first cutting of a workpiece to prepare the workpiece for further processing in the workpiece processing system 104 and/or to generate trim for use in the trim use assembly, such as in the treatment solution assembly 122 and/or another use (e.g., with the secondary processing assembly 128).

The first cutting assembly 120 may be configured to cut a workpiece horizontally and/or vertically. In other words, the first cutting assembly 120 may be configured to horizontally cut a workpiece substantially parallel to a conveyance surface of the conveyance assembly 130 and/or the first cutting assembly 120 may be configured to vertically cut a workpiece substantially transverse to a conveyance surface of the conveyance assembly 130. In some examples, the first cutting assembly 120 includes a slicer assembly configured to cut a workpiece horizontally. In some examples, the first cutting assembly 120 includes a high-speed portioner configured to cut a workpiece vertically. The first cutting assembly 120 may include any suitable number and combination of horizontal and/or vertical cutters.

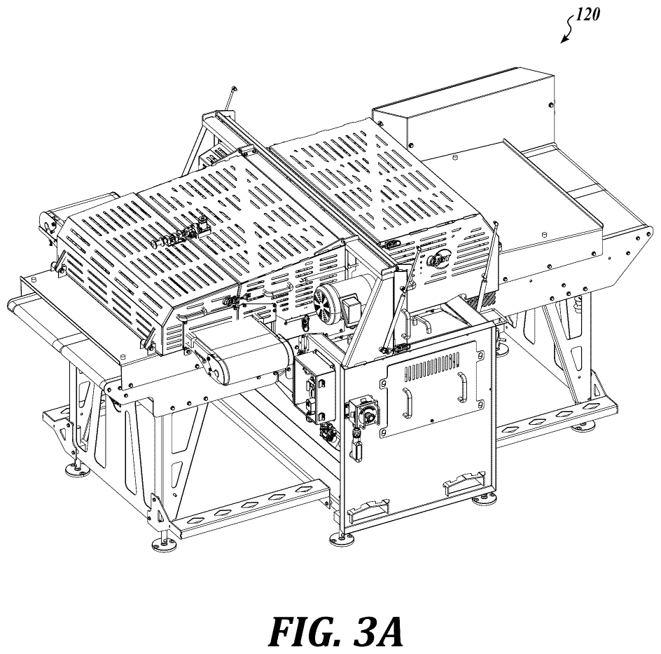

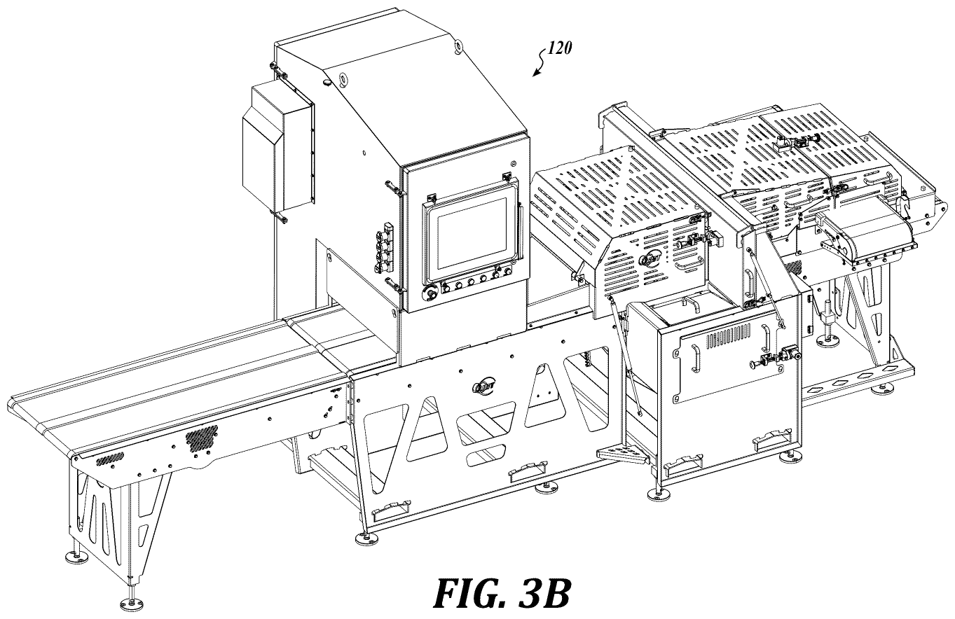

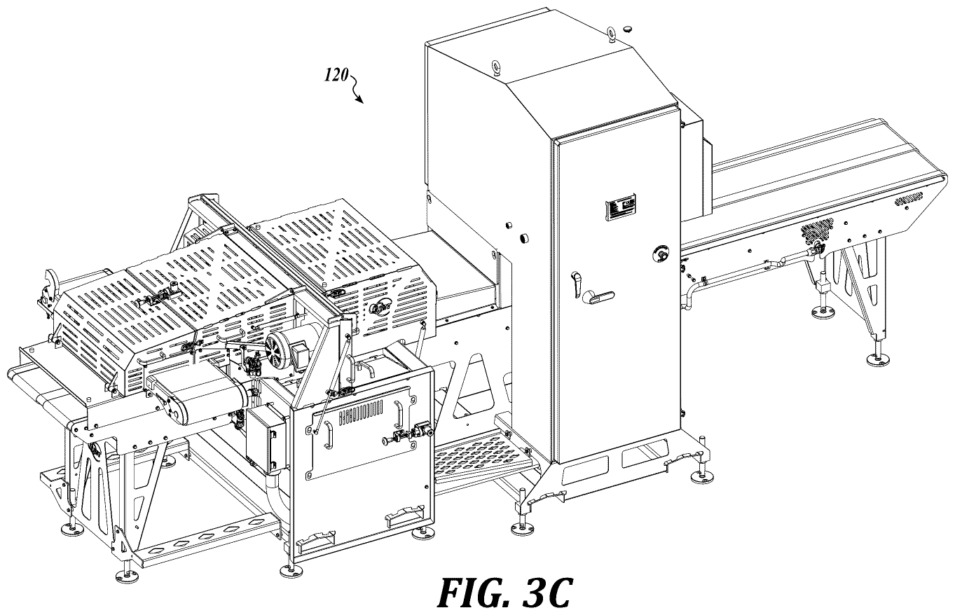

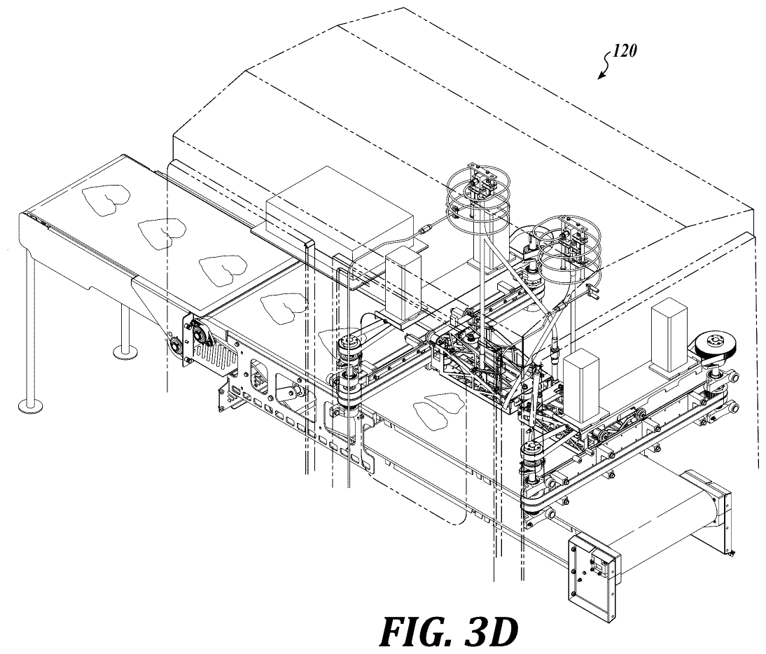

If configured as a slicer assembly, the first cutting assembly 120 may include one or more slicers configured to horizontally slice the workpieces into one or more desired thicknesses of cuts. For example, each slicer may be in the form of a high-speed, continuously moving blade, a high-speed water jet, a laser, a rotary saw, a hacksaw, or band saw. The slicers may be adjustable to cut at different heights automatically through a controller (e.g., the processing computing device 132), manually, or a combination thereof. In some examples, the slicer assembly includes one or more of a DSI™ Adaptive Slicer or a DSI™ CT 32 Consistent Thickness Slicer™ available from JBT Corporation of Chicago, Il. (shown in FIGS. 3A and 3B and 3C, respectively) (see also U.S. Pat. No. 8,683,903, entitled “Compliant hold-down conveyor for slicer,” incorporates by reference herein in its entirety).

The slicer may be configured to horizontally slice workpieces in first and second lanes to first and second thicknesses of cuts. For instance, workpieces of a first size sorted to a first lane may be cut to a first thickness, and workpieces of a second size sorted to a second lane may be cut to a second thickness. As a specific example, the first size may be of a height that allows for a double portion to be produced from the workpiece (e.g., a chicken fillet having an average height that can produce two breakfast sandwich portions from a horizontally sliced puck shape). As such, workpieces in the first lane may be sliced to a thicker cut to allow for the workpiece to be later cut into two portions. The second size may be of a height that does not allow for a double portion to be produced from the workpiece. As such, workpieces in the second lane may be sliced to a thinner cut that is not later cut into two portions. The thinner cut thickness may be thicker than a halved portion forming the double portion workpiece and may substantially match an end product thickness (e.g., chicken fillet cut to a dinner portion). In this configuration, the slicer may be configured to slice at fixed heights according to the workpiece specifications (e.g., using a DSI™ CT 32 Consistent Thickness Slicer™).

The slicer may also be controllable and/or adjustable so that a thickness of each individual workpiece is optimized. For instance, a slicer conveyance system may be adjustable in height to adjust the location of the slicer horizontal cut for each workpiece (e.g., using a DSI™ Adaptive Slicer). In that manner, the slicer can cut each workpiece to a preferred thickness that is optimal for that workpiece. In such an example, the slicer may incorporate a vision system that may be a part of or separate from the vision system of the sensor assembly 116. The vision system may capture data of incoming workpieces to assess a physical characteristic(s) of the workpiece, such as height or weight. Based on the workpiece physical characteristic(s), the workpiece may be sliced to a preferred thickness.

In some examples, the slicer is servo-controlled for adjusting the position of the slicer relative to an optionally fixed slicer conveyance system to adjust the location of the slicer horizontal cut for a workpiece(s) (e.g., using a servo-controlled slicer on a DSI™ CT 32 Consistent Thickness Slicer™). In such an example, the slicer may incorporate a vision system that may be a part of or separate from the vision system of the sensor assembly 116. The slicer vision system may capture data of incoming workpieces to assess a physical characteristic(s) of the workpiece, such as height or weight. The vision system may also or instead be downstream of the slicer. For instance, the vision system may include a part of the second cutting assembly 124, such as an optical scanner of a portioner. Sliced workpiece physical characteristic(s), such as height, weight, shape, size, etc., may be determined by either the slicer vision system or the downstream (portioner) scanner and analyzed by the processing computing device 132. The processing computing device 132 can then output instructions to the servo-slicer of the first cutting assembly 120 for adjusting workpiece slice thickness.

In some examples, manual adjustments may also or instead be made to the slicer to adjust the slicing height, such as based on output instructions from the processing computing device 132 indicating a recommended adjustment. For instance, the processing computing device 132 may output a recommended slicer height that is displayed on an HMI display screen of the workpiece processing system 104, and based on the displayed instructions, an operator may make manual adjustments to a slicer.

The preferred thickness for a slicer of the first cutting assembly 120 may be based on workpiece characteristics (e.g., thickness, weight, etc.), workpiece end product specifications, trim specifications, data sent from the workpiece utilization computing device 110 regarding raw workpiece supply/demand (e.g., larger incoming chicken breast fillets may be sliced differently to define a double cut portion) and/or finished workpiece supply/demand requirements (e.g., there is a certain demand for ⅜″ thick cuts v. 1″ cuts, so the slicer is adjusted to meet the demand), etc. The slicer adjustments may be under the control of a processor, such as the processing computing device 132.

In some examples, the slicer height may be adjusted to target a sliced workpiece weight that is within an acceptable range of workpiece thicknesses or heights. For instance, a workpiece may be sliced to a thickness between 18-24 mm to reach a target weight of 3 ounces. The sliced workpiece thickness may be determined, for instance, based on a weighted value of finished thickness and a weighted value of finished weight as analyzed by an optimizer program, such as the DSI Q-LINK™ Portioning Software developed by Design Systems, Inc. of Redmond, Washington.

In some examples, the slicer height may be adjusted to target a sliced workpiece weight or thickness that is within an acceptable range of excess trim generated by the system. For instance, a workpiece(s) may be sliced at a certain thickness to produce a finished workpiece that is high in demand and provides an overall higher yield even when excess trim is generated. A sliced workpiece thickness may be determined, for instance, based on a weighted value of finished thickness and a weighted value of excess trim as analyzed by an optimizer program, such as the DSI Q-LINK™ Portioning Software noted above.

As noted above, the first cutting assembly 120 may also/instead be configured as a high-speed portioner. In that regard, the first cutting assembly 120 may include one or more cutters of a high-speed portioner, such as a high-speed waterjet cutter. In some examples, the first cutting assembly 120 includes a DSI™ 812 Compact Portioning System, available from JBT Corporation of Chicago, Il. shown in FIG. 3D (see also U.S. Patent App. Pub. No. 20240033868, entitled “Processing apparatus,” incorporates by reference herein in its entirety).

Using a high-speed portioner in the first cutting assembly 120 can enable workpieces to be vertically sliced. Vertical slicing allows for preliminary trimming or portioning of the workpieces to support downstream aspects of workpiece processing. For instance, a primal product (a cut of meat initially separated from the carcass of an animal during butchering or processing) may be cut into a sub-primal product before further processing by the workpiece processing system 104. If the primal product is a chicken butterfly, the high-speed portioner may be used to cut the butterfly into a chicken breast fillet. The high-speed portioner may be configured to vertically slice workpieces in first and second lanes to different specifications.

In some examples, a high-speed portioner(s) may be used in the first cutting assembly 120 together with a horizontal slicer(s). Specifically, a high-speed portioner(s) may be positioned downstream or upstream of a horizontal slicer(s), as shown in FIG. 9. For instance, the slicer may be first used to slice the primal product horizontally to a desired thickness, and the high-speed portioner(s) may be used to cut the primal product into a sub-primal product (or vice versa). A slicer may slice chicken butterflies to a desired thickness (such as based on end product requirements). The chicken butterflies may then be cut by a high-speed portioner(s) into chicken breast fillets.

Untreated (unmarinated) trim will be generated at the first cutting assembly 120, such as during both the high-speed portioning step and the horizontal slicing step. Some of the untreated trim may be designated for resale or secondary processing, and some of the untreated trim may be designated for marination. To optimize use of the trim, only a necessary amount of untreated trim is generated and used for marination production, and a remaining amount of untreated trim can be designated for resale or secondary processing.

If the high-speed portioning step of the first cutting assembly 120 was eliminated, at least some of the trim would likely be treated (marinated) trim, which would likely decrease the overall value of the trim. Treated trim is typically not used for treatment solution production because the final content of trim in the solution would be difficult to discern. Moreover,, treated trim cannot be as easily re-sold or re-used because it cannot be treated according to another manufacturer's specifications. Thus, treated trim often has a lower value. An example using chicken butterflies will be provided to illustrate this point.

In this example, the first cutting assembly 120 includes only a horizontal slicer, and entire chicken butterflies are sliced to a desired thickness. The trim generated during horizonal slicing is diverted to a first portion of the treatment solution assembly 122 for marination production (with any excess trim being diverted to another portion of the trim use assembly, such as the secondary processing assembly 128), and the sliced butterflies are diverted to a second portion of the treatment solution assembly 122 for treatment (e.g., injection) with the marinate. The treated butterflies then proceed to other components of the workpiece processing system 104, such as the second cutting assembly 124. At the second cutting assembly 124, the treated butterflies are portioned, trimmed, etc., into a shape/size suitable for an end product. Trim generated during cutting at the second cutting assembly 124 would be treated, less valuable trim.

Thus, in some preferred examples of processing chicken butterflies or the like to be treated (e.g., marinated), the first cutting assembly 120 includes a high-speed portioner(s) located upstream or downstream from a horizontal slicer(s) that can be used to cut the butterflies into chicken fillets before treatment. In such a preferred example, trim generated during vertical cutting of the butterflies into chicken fillets at the first cutting assembly 120 would be untreated, higher value trim.

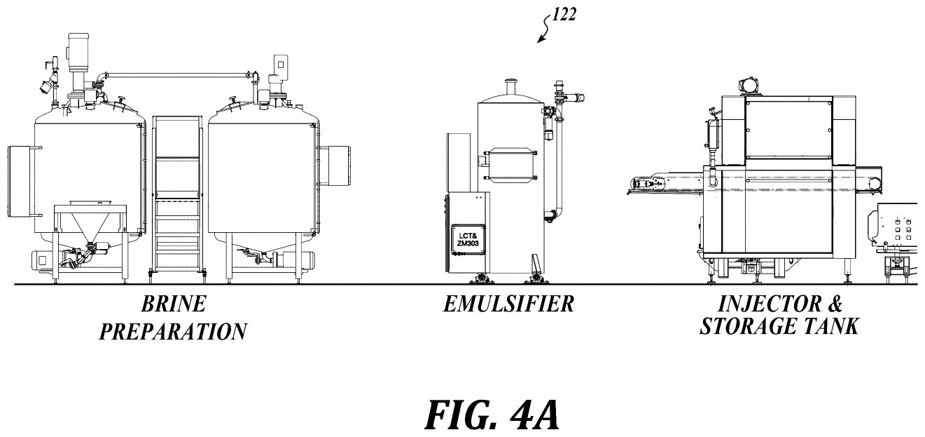

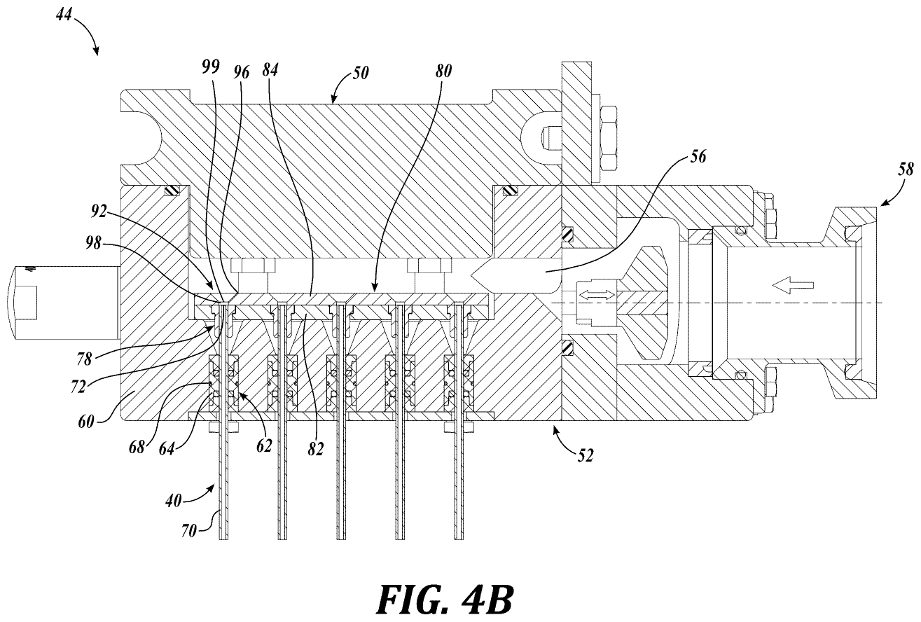

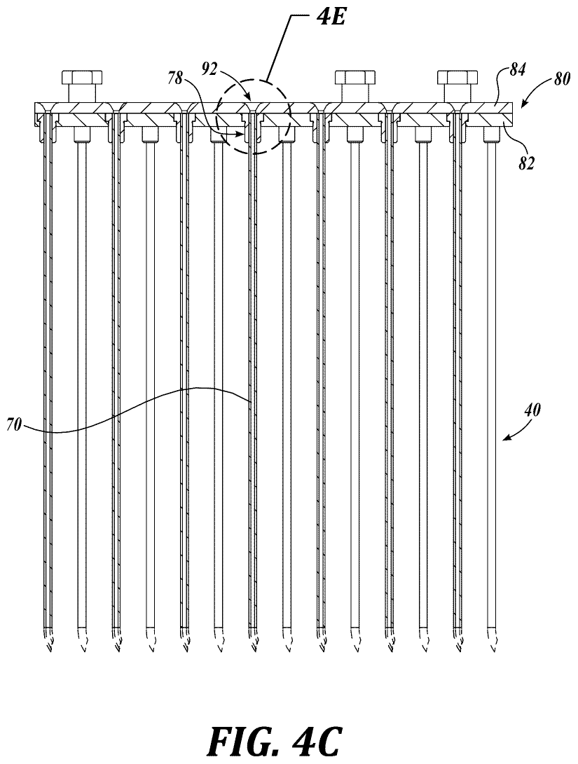

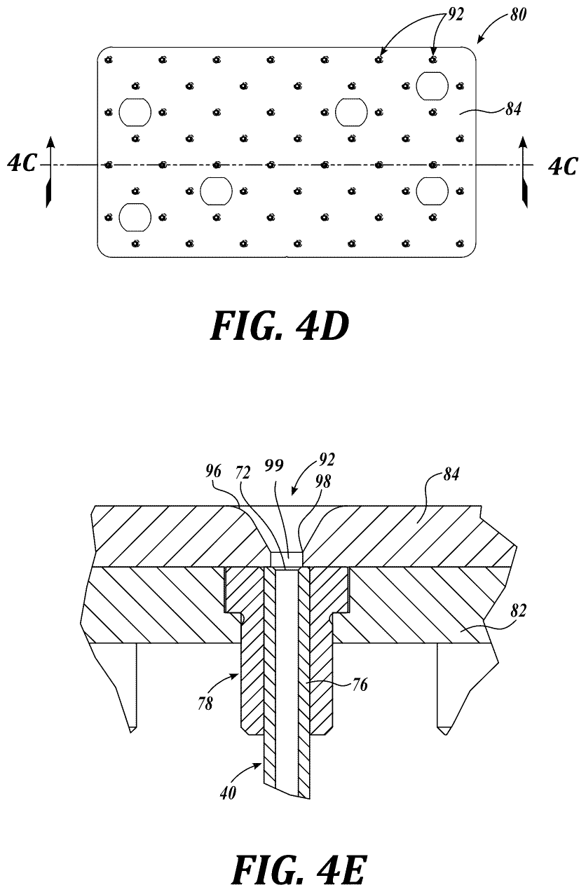

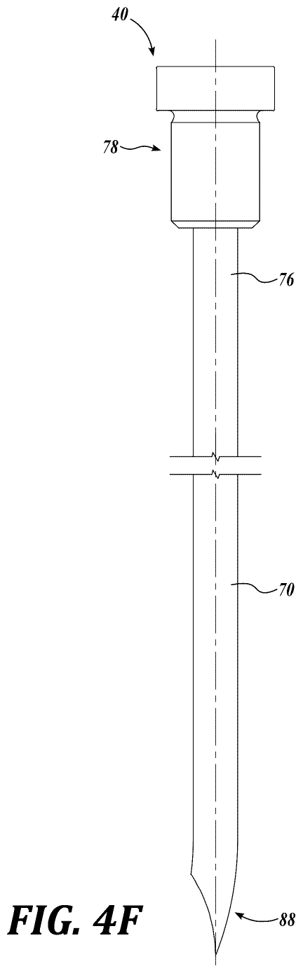

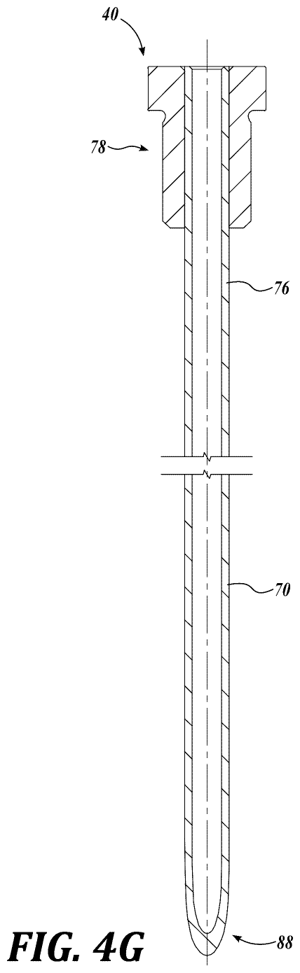

The treatment solution assembly 122 of the trim use assembly will now be generally described with additional reference to the exemplary treatment solution assembly 122 depicted in FIG. 4A. In general, the treatment solution assembly 122 may be configured for producing a treatment solution for the workpieces and/or treating workpieces with a treatment solution. The treatment solution may be referenced as a brine, a marinade, a pickling solution, or the like and should not be seen as limiting.

The treatment solution assembly 122 may include a brine preparation station, an emulsifier, and an injector and associated mixing and/or storage tank. The injector generally includes an array of injection needles supported by a needle carrier. Ingredients from the brine preparation station, typically in batch format, may be added to the emulsifier, and the combined ingredients may be run for a predetermined amount of time (e.g., about two minutes) through an emulsifier plate. The emulsified solution may be stored in the mixing and/or storage tank until ready to be used by an injector.

In some examples, portions of the equipment used to make the treatment solution, such as the mixing and/or storage tank, etc., may include insulating materials or temperature control features to substantially maintain the treatment solution in the tank at a desired temperature. In some examples, a refrigeration or cooling device may be used to bring trim and/or workpieces to a treatment temperature and substantially maintain the trim and/or workpieces at the treatment temperature.

As noted above, the sensor assembly 116 may include a temperature sensor system configured to capture and monitor a temperature of the trim and/or workpieces before, during, and/or after use or treatment at the treatment solution assembly 122. The temperature sensor system may be configured to output temperature sensor data to one or more temperature controllers and/or a computing device of the workpiece processing optimization system 102 that communicates with a temperature controller, such as the processing computing device 132, the trim optimization computing device 106, and/or the data processing computing device 107.

Controlling the temperature of the trim, workpieces, and other treatment solution ingredients, such as water, can impact the outcome or effectiveness of the treatment solution, such as its solubility, viscosity, purge after injection, flow through the injector, etc. The effectiveness of the treatment solution directly affects workpiece yield and quality. For instance, if a treatment solution produces minimal purge after injection, workpiece yield can be maximized. Moreover, if the treatment solution is effectively formulated to minimize purge, less treatment solution (and therefore, less trim) can be used to achieve desired yield. In that regard, by controlling the temperature of the trim, workpieces, and other treatment solution ingredients, treated workpiece yield and trim use can be optimized.

The treatment solution may be formulated in accordance with the systems and methods described in U.S. Provisional Patent Application Nos. 83/617,897, entitled “Low Salt, Low Viscosity Functional Brine”, the entire disclosures of which are incorporated by reference herein. The treatment solutions may be identified by the designation “LVB solution” or similar, which signifies a low viscosity brine. In examples where the treatment solution includes water, such as with the LVB solution, part of the water may be provided in the form of ice to result in a treatment solution during and after emulsification that is below a desired temperature, such as below 0° C.

The treatment solution may be formulated with trim of the workpiece to be treated, a small amount of salt (or sodium chloride (NaCl), commonly known as table salt), and water. In one example, the trim used to produce any treatment solution may be generated by the first cutting assembly 120 of the workpiece processing optimization system 102. A temperature of the trim used to produce any treatment solution may be achieved/controlled by a temperature control feature of the workpiece processing optimization system 102 in response to trim temperature sensor data captured by the sensor assembly 116.

The trim of the workpiece to be treated may include meat protein from the muscle of the workpiece and a portion of fat. The amount of fat in the trim may be determined from an analysis of image sensor data of the sensor assembly 116. For instance, as noted above, the sensor data processing engine 1114 of the processing computing device 132 may be configured to generate a fat recognition (FRS) object view from data captured with an optical scanner. The FRS object view of workpieces and/or trim may be analyzed to determine a level of fat within the trim and/or a cutting strategy for producing trim with a target level of fat. As will be described further below, the trim optimization computing device 106 may use data pertaining to the trim fat level to make any adjustments to the first cutting assembly 120 to produce trim with a target level of fat.

In the example of boneless, skinless, chicken butterflies or fillets, the treatment solution may be formulated with ground boneless, skinless, chicken trim, a small amount of salt, and water. The level of salt used in the treatment solution may be based on a target of about 0-0.3% salt content in the final or treated workpiece.

The treatment solution may be applied to the workpieces in any suitable manner, such as by soaking, tumbling, or injecting. If an injector is used, the injector may be configured to optimize injection of the workpieces with the LVB solution.

For instance, if injecting boneless workpieces, such as boneless chicken breast filles or butterflies, a top port needle carrier may be preferred for ease of use and maintenance. Such a top port needle carrier may be configured to guide treatment solution having emulsified protein (e.g., trim) from a supply chamber into the openings of injection needles without inducing substantial shear on the treatment solution.

An exemplary top port top port entry needle carrier 44 and corresponding exemplary needles 40 for use with the top port needle carrier will now be described with reference to FIGS. 4A-4G.

FIGS. 4F and 4G show an example of an injection needle 40 for use with the top port top port entry needle carrier 44. In general, the injection needles 40 are constructed with an elongated hollow shank 70 having an upper end 76 defining a top opening 72. The upper end 76 is securely engaged within an inner opening of a stepped needle head 78, which is constructed to receive the plunging force used to insert a needle tip 88 (opposite the upper end 76) into the food product being treated. An upper, substantially flat surface of the elongated hollow shank 70 (surrounding the top opening 72) is substantially flush with the upper, substantially flat surface of the stepped needle head 78.

Referring to FIGS. 4B and 4C, the exemplary top port entry needle carrier 44 includes a carrier upper section 50 and a carrier lower section 52 to define a feeder supply chamber 56 therebetween. As is standard, the feeder supply chamber 56 is connected to a source of brine and in brine flow communication with the injection needles 40. In the example shown, the top port entry needle carrier 44 includes an inlet port 58 configured for connecting the feeder supply chamber 56 to a source of brine, such as a brine storage tank.

The array of injection needles 40 are supported by the carrier lower section 52 of the top port entry needle carrier 44. Specifically, the injection needles 40 extend vertically and transversely through a lower, horizontal body portion 60 of the carrier lower section 52. A sealing assembly 62 may be used to sealingly secure the elongated hollow shank 70 of each of the needles within the horizontal body portion 60 of the carrier lower section 52 in a manner well known. For instance, the sealing assembly 62 may include a sealing member 64 disposed within a counter bore 66 extending upwardly from a bottom surface of the horizontal body portion 60. Seal rings 68 are retained within the counter bore 66 between the needle elongated hollow shank 70 and the sealing member 64 to closely receive the needles 40.

The exemplary top port entry needle carrier 44 is configured to support an optimal delivery of LVB solution to the injection needles 40 for the food product to be treated. The top port entry needle carrier 44 may be configured as either a side port entry manifold carrier, where a side inlet port in the needle is in registry with the feeder supply chamber 56, or a top port entry manifold carrier, where a top opening of the needle is in registry with the feeder supply chamber 56.

Side port entry manifold carriers support retraction of the injection needles. Accordingly, side port entry manifold carriers are suitable for injecting food products having bones or other materials that would necessitate retraction of the needles. Side port entry manifold carriers are also typically used to inject brines having a viscosity higher than water or a clear (e.g., broth) brine, such as the LVB solution described herein, or a high viscous brine (HVB) solution (such as one or more of the brines described in U.S. patent application Ser. No. 16/887,075, entitled “High Viscosity Brine For Whole Poultry”, U.S. patent application Ser. No. 18/065,148, entitled “Brine Without Phosphates And Either Salt Free Or Low Salt”, and U.S. patent application Ser. No. 18/417,551, entitled “System and Method for Treating Shrimp and Other Crustaceans”, incorporated by reference herein in their entireties). An exemplary injection system having a side port entry manifold carrier is disclosed in US2022/0110348 A1, entitled “Pork belly processing”, which is incorporated herein by reference in its entirety.

A viscous brine can more easily flow into a side port inlet of a needle that is in registry with the feeder supply chamber 56 (as with a side top port entry manifold) than through a small top opening in the needle (as with a top port entry manifold). Thus, many viscous brines are injected into food products with a side top port entry manifold carrier, whether the food product includes bones or not. However, as will become further appreciated below, components of a viscous brine, including a brine with emulsified protein, such the LVB solution described herein, can build up in a side port entry manifold carrier due at least in part to bends/turns/edges in the brine flow path. Moreover, side port entry manifold carriers are more difficult to clean and maintain. Thus, if injecting food products without bones or the like (e.g., boneless chicken breast fillets or chicken butterflies), a top portion entry manifold carrier may be preferred.

As noted above, however, top portion entry needle carriers are not typically used to inject brines having emulsified protein or other viscous brines. The top port entry needle carrier 44 shown and described herein overcomes the typical limitations associated with the flow of brines. In other words, in examples where the food product to be treated is boneless or otherwise does not require needle retraction, the top port entry needle carrier 44 may be configured with an improved top port entry manifold configured to support flow of a brine having emulsified protein, such as the LVB solution. Exemplary aspects of the improved top port entry needle carrier 44 suitable to support flow of a brines having emulsified protein, such as the LVB solution, will now be described.

As generally noted above, in a top port entry needle carrier, the top opening 72 in the upper end 76 of each of the injection needles 40 is in fluid communication with the feeder supply chamber 56. In this manner, fluid may flow through the feeder supply chamber 56 into the needle top opening 72, through the elongated hollow shank 70, and out a needle tip opening (not shown in FIG. 4). In the exemplary top port entry needle carrier 44, the injection needles 40 are secured within the carrier lower section 52 and positioned relative to the feeder supply chamber 56 with a top port needle manifold plate assembly 80.

The top port needle manifold plate assembly 80 includes a substantially planar bottom plate 82 that rests against an upper surface of the carrier lower section 52. The bottom plate 82 includes a plurality of openings sized and configured to receive and vertically restrain, in a first direction, a corresponding number of injection needles 40. For instance, the bottom plate 82 includes openings sized and shaped to receive the stepped needle head 78 such that the injection needles 40 are vertically restrained from moving downward when received within the lower plate. In that regard, the openings in the bottom plate 82 are inversely stepped to substantially match the size and shape of the stepped needle head 78.

The openings in the bottom plate 82 are also configured to dispose an upper, substantially flat surface of the stepped needle head 78 of each of the injection needles 40 substantially flush with an upper, substantially flat surface of the bottom plate. In this manner, the upper, substantially flat surface of the elongated hollow shank 70 (surrounding the top opening 72) is substantially flush with the upper, substantially flat surface of the bottom plate 82.

The top port needle manifold plate assembly 80 further includes a substantially planar top plate 84 configured to vertically restrain, in a second, opposite direction, the injection needles 40. The top plate 84 is secured against the bottom plate 82, such as with a plurality of fasteners, such that a body 86 of the top plate 84 at least partially interferes with the stepped needle head 78 of each of the injection needles 40. In this manner, the top plate 84 prevents the stepped needle head 78 from moving vertically upward.

The top plate 84 is also configured to allow treatment solution or brine to flow from the feeder supply chamber 56 into the top opening 72 of each of the injection needles 40. In a typical top port manifold carrier, the upper plate (or similar) includes cylindrical openings extending transversely through the upper plate that have substantially the same diameter as an inner diameter of the injection needles 40. In that regard, the cylindrical openings in the top plate can essentially form an extension of the elongated hollow shank 70 of the needle, allowing brine to make a 90 degree turn and flow downwardly into the needle from the feeder supply chamber 56.

In the exemplary top port entry needle carrier 44 disclosed herein, the top plate 84 includes specially designed, upper plate through-holes 92 configured to support an efficient and optimized flow of brine from the feeder supply chamber 56 into the needles 40. More specifically, the upper plate through-holes 92 are designed to facilitate a low shear, low heat brine flow path into the injection needles 40. In that regard, the upper plate through-holes 92 are designed to transition the flow of brine into the corresponding injection needles 40 smoothly and efficiently.

In the depicted exemplary embodiment, the upper plate through-holes 92 are generally an inverted frusto-conical shape. A larger end opening 96 of each of the upper plate through-holes 92 intersects the top surface of the top plate 84, and a smaller end opening 98 of each of the upper plate through-holes 92 is located near the bottom surface of the top plate 84.

The brine can flow along a top surface of the top plate 84 and thereafter into the inverted frusto-conical shaped opening without encountering a sharp turn in the flow path. In that regard, the upper plate through-holes 92 are essentially splayed out as they extend to the top surface of the top plate 84. The brine can flow gently downwardly at an angle into the upper plate through-holes 92 towards the injection needles 40.

The soft turn in the brine flow path as it enters the upper plate through-holes 92 substantially prevents build-up at the intersection of the upper plate through-hole 92 and the top surface of the top plate 84. By comparison, a typical, cylindrically-shaped top plate opening defines a brine flow path having a 90 degree turn (i.e., from the top surface of the top plate 84 into the opening). Build-up (e.g., attached collagen fibers) can occur on a cylindrically-shaped top plate opening when using anything but a clear brine, such as a brine containing ground substrate like the LVB solution described herein. The substrate in the brine can build up at the corner of the turn. The frusto-conical design of the upper plate through-holes 92 substantially prevents build-up at the top of the upper plate through-holes 92 by eliminating the sharp turn. It should be appreciated that any other suitable shape may instead be used to substantially prevent build-up.

The upper plate through-holes 92 may also be designed to support a substantially smooth, low-shear flow of brine from the feeder supply chamber 56 toward the injection needles 40. In that regard, each of the upper plate through-holes 92 may be curved at its upper edge, or at the intersection between the larger end opening 96 and the top surface of the top plate 84. In this manner, brine can flow along the top surface of the top plate 84 and into the upper plate through-holes 92 without encountering a sharp edge that could induce shear.

The upper plate through-hole 92 is also configured to interface with the corresponding injection needle 40 in a manner that continues a smooth, low-shear flow path of the brine into the needle. In the depicted example, a cylindrical section 99 extends from the smaller end opening 98 of each of the upper plate through-holes 92. The cylindrical section 99 extends to the bottom surface of the top plate 84. A bottom, substantially flat surface of the cylindrical section 99 may be substantially flush with a bottom surface of the top plate 84. In this manner, the substantially flat upper surface of the needle upper end 76, positioned substantially flush with the top surface of the bottom plate 82, can abut up against the bottom surface of the cylindrical section 99. Thus, the upper plate through-holes 92 are designed to facilitate a vertical brine flow path that has substantially no gaps between components defining the path. It can be appreciated that any gaps between the top plate 84 and the injection needles 40 could result in leakage and disruption of flow, among other issues.

The brine flow path defined between the upper plate through-holes 92 and the injection needles 40 is also substantially free of any sharp edges or protrusions that could generate a shear force on the brine. In one aspect, the interior walls of the upper plate through-holes 92 and the injection needles 40 are substantially free from sharp edges or protrusions that would disturb the brine flow path. In that regard, the larger end opening 96 of each of the upper plate through-holes 92 may be curved at its upper edge, as noted above. In this manner, brine can flow along the top surface of the top plate 84 and into the upper plate through-holes 92 without encountering a sharp edge that could induce shear. The intersection or transition between the smaller end opening 98 and the cylindrical section 99 may be similarly curved.

Moreover, the interior walls defining the upper plate through-holes 92 and the upper end 76 of the injection needles 40 may be substantially aligned, thereby eliminating sharp edges or protrusions between components. For instance, the cylindrical section 99 may be substantially the same diameter as an inner diameter of the needle elongated hollow shank 70 along at least a portion of the upper end 76.

In other examples, such as in the needle 40 shown in FIG. 6, the upper end of the elongated hollow shank 70 may include a chamfered top opening 72, and the cylindrical section 99 may be substantially the same diameter as an outer diameter of the chamfer defined at the top surface of the elongated hollow shank 70. In that regard, the chamfer can define a smooth, gentle transition between the cylindrical section 99 and the interior of the needle elongated hollow shank 70. In any event, a longitudinal axis of the upper plate through-hole 92 may be substantially aligned with a longitudinal axis of the corresponding injection needle 40, as shown. As a result, a substantially smooth, uninterrupted vertical flow path is defined between the top plate 84 and the injection needle 40.

It should be appreciated that in some examples, the cylindrical section 99 is eliminated, and an aligned, uninterrupted interface is instead defined between the smaller end opening 98 of the upper plate through-hole 92 and the upper end 76 of the injection needle 40. In any event, brine can flow smoothly and easily through the upper plate through-hole 92 and into the respective needle, without any gaps, edges, or the like causing a disruption in flow or shear force on the brine.

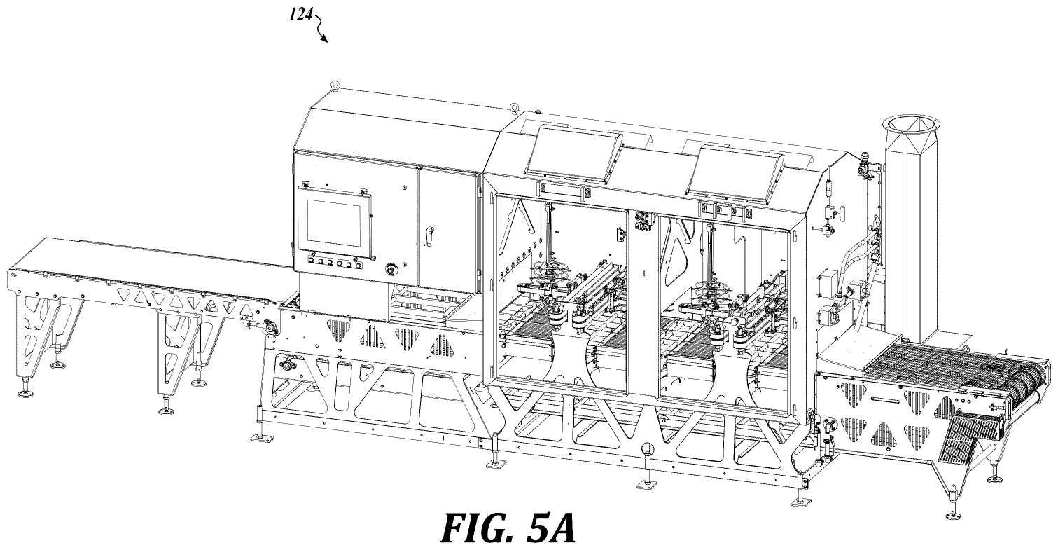

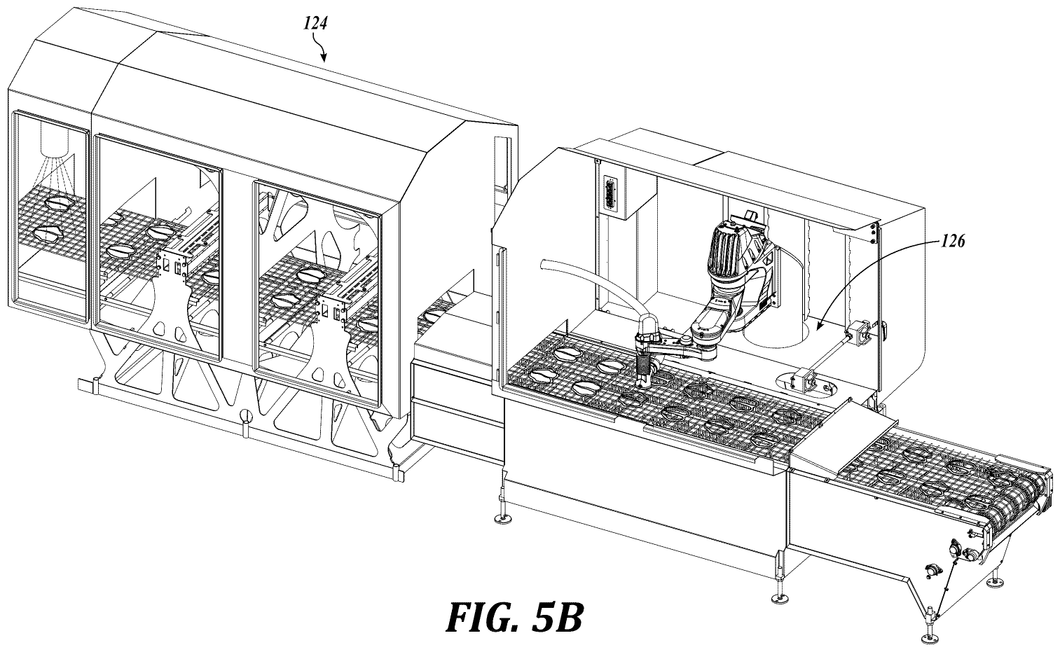

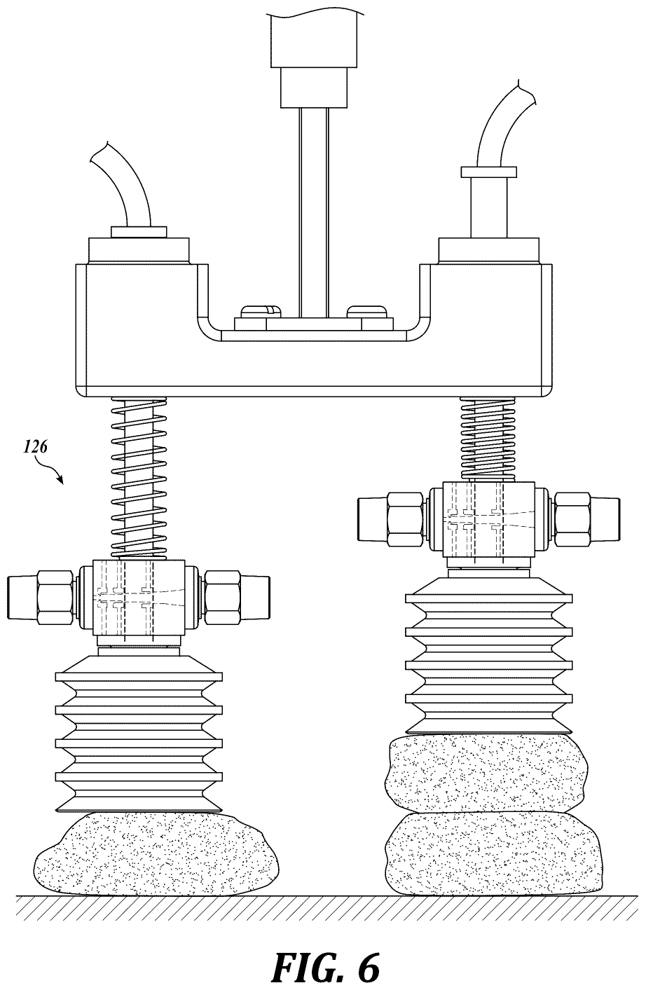

Further details of the exemplary injection needles 40 for use with the top port entry needle carrier 44 and an LVB solution, such as that described herein, will now be described with reference to FIGS. 5F and 5G. As noted above, each of the injection needles 40 includes an elongated hollow shank 70 having a top opening 72 defined in an upper end 76. The upper end 76 is tightly received within a stepped needle head 78, which is configured to receive a plunging force of the injector when secured within the bottom plate 82, as described above. A needle tip 88 is defined on the end of the elongated hollow shank 70 opposite the upper end 76. The needle tip 88 is configured to penetrate a food product and direct brine out an outlet opening into the food product.

Generally, the construction of the needle tip 88, as well as other aspects of the injection needle 40, may be any type suitable for a top port injection manifold carrier, such as the top port entry needle carrier 44 described herein. For instance, the needle configuration may be in the form of a hypodermic needle having an outlet opening at the bottom or distal end of the needle tip 88, as shown in FIG. 5F. A hypodermic needle configuration is capable of directing brine downward and sometimes laterally into the food product.

Another type of needle tip configuration is a side port exit tip needle, which has one or more side outlets at a location spaced above a bottom or distal end of the needle tip, to release brine laterally or sideways out of the needle. The side port exit tip needle configuration functions well to direct the brine sideways into the food product from the one or more needle side outlets. Various types of injection needle tips are shown and described in U.S. Patent App. Pub. No. US2022/0110348 A1 and U.S. patent application Ser. No. 18/326,366, entitled “Hypodermic Injection Needle and Systems and Methods Including the Same”, incorporated herein by reference in its entirety.

As can be appreciated, a needle array that uses one or more types of needles can advantageously be employed to distribute the brine uniformly throughout the depth or thickness of certain types of food products, for example, plant-based food products. For instance, a needle array that uses both side port exit tip and hypodermic needles may help distribute the brine throughout both the upper and lower portions of the food product. Specifically, the side port exit tip needles may help distribute the brine throughout the upper portions of the food product, while the hypodermic needles may help distribute the brine throughout the lower portions of the food product.

Regardless of the type of needle used, the injection needle 40 may be configured for use with a top port manifold carrier configured to allow optimal flow of brine through the carrier manifold and into the needle, such as the top port entry needle carrier 44 described herein. For instance, as noted above, the inner diameter of the upper end 76 of the needle elongated hollow shank 70 may be substantially the same as the inner diameter of the cylindrical section 99 of the upper plate through-hole 92 (and/or the same size as the diameter of the smaller end opening 98 if the cylindrical section 99 is omitted). In that regard, the injection needles 40 may be substantially aligned with the cylindrical section 99, thereby eliminating sharp edges or protrusions between components. In the examples shown herein, the upper end of the elongated hollow shank 70 includes a chamfered top opening 72, and the cylindrical section 99 may be substantially the same diameter as an outer diameter of the chamfer defined at the top surface of the elongated hollow shank 70.

A typical injection needle has an outer diameter of about 3 mm with walls about 0.75 mm in thickness, leaving an internal bore of about 1.5 mm. Corresponding upper plate openings for a prior art top port manifold would include bored cylindrical openings that match the internal bore size of the needles, or 1.5 mm.

An internal bore size of only 1.5 mm for the upper plate through-holes 92 may be insufficient for supporting flow of a brine having emulsified protein. Thus, in examples described herein, the top port entry needle carrier 44 is designed to have upper plate through-holes 92 having an internal bore (e.g., the inner diameter of the cylindrical section 99 and/or the smaller end opening 98 of the upper plate through-hole 92) that is larger than prior art top port manifold openings. For instance, the cylindrical section 99 and/or the smaller end opening 98 of the upper plate through-hole 92 may have an inner diameter of 2 mm.

The injection needles 40 may be designed to correspondingly include a larger internal bore to match a larger diameter upper plate opening, such as 2 mm. In some aspects, a design constraint may include the outer diameter of the elongated hollow shank 70. For instance, using a needle that has an outer diameter of 3.5 mm to accommodate an internal bore of 2 mm may not be desired for various reasons. For instance, a larger diameter needle may cause damage to the food product during penetration.

In one example, the wall of the injection needles 40 along the elongated hollow shank 70 are reduced in thickness to increase the internal bore of the needle. For instance, referring to the cross-sectional view of the injection needles 40 shown in FIG. 5G, the walls of the elongated hollow shank 70 on each side of the internal bore may be reduced to 0.5 mm, leaving an internal bore size of 2 mm and the same outer diameter of 3 mm. Any suitable material may be used to make a “thin-walled” needle, such as a needle having a wall thickness of 0.5 mm. For instance, a material that is sufficiently flexible and designed to bend rather than break upon insertion may be used. The improved needle design supports the flow of brines having emulsified protein or another type of viscous brine through the top port needle manifold plate assembly 80 and into the injection needles 40 without compromising injection quality.

It can be appreciated that the top port manifold design of the top port entry needle carrier 44 helps support optimal flow of brines having emulsified protein through the carrier. For instance, the flared upper plate through-holes 92 allow the brine to easily and gently flow into the injection needles 40, reducing the change of buildup and shear stress. The needles are also uniquely designed to support a larger internal upper plate openings bore, allowing a thicker, viscous brine to more easily flow therethrough.

The improved design of the top port entry needle carrier 44 and the injection needles 40 reduces the shear stress placed on the brine during injection and substantially maintains the low temperature of the brine. This has the advantage of minimizing the loss of functionality of the active substrate protein (e.g., ground trim) in the brine. Further, heat build-up in the needles is kept to a minimum. Such heat can denature, or otherwise damage, the active substrate protein in the brine. Thus, the improved top port manifold and needle design described herein supports an optimal low shear, low heat brine flow.

Other aspects of the treatment solution assembly 122 may also be advantageously configured to support an optimal low shear, low heat brine flow. For instance, the trim, workpieces, and/or treatment solution ingredients (water) can be brought to an held at a desired treatment temperature suitable for supporting treatment solution formulation and injection. Moreover, components of the treatment solution assembly 122 configured to supply formulated brine to the top port entry needle carrier 44 (e.g., from the from the storage tank) may be designed to induce minimal shear on the brine and substantially maintain the low temperature of the brine.

In some examples, the brine supply system uses a single, simple valve located between the brine storage tank (or saddle tank) and the top port entry needle carrier 44 for supplying brine to the carrier. The single, simple valve opens and closes to flood the manifold in the top port entry needle carrier 44. Using only a simple, single valve reduces the chance of brine protein build-up.

In some examples, the brine supply system of the treatment solution assembly 122 uses a diaphragm pump rather than a centrifugal pump or other type of pump utilizing a rotating impeller. A rotating impeller or the like continuously cuts through the brine, damaging and/or altering the nature of the active substrate protein in the brine. Moreover, a centrifugal pump or similar continues to run and induce shear (and generate heat) in the brine, even when the valve is closed and no brine is flowing to the top port entry needle carrier 44. A diaphragm pump, on the other hand, need only operate when called upon to direct brine to the top port entry needle carrier 44 and through the injection needles 40 (e.g., during a pressure drop). As such, less shear stress is placed on the brine when using a diaphragm pump or similar. Thus, it can be appreciated that the low complicated, optimally designed brine supply system minimizes opportunities to induce shear in the brine and cause heat and build-up.

A brine return system of the treatment solution assembly 122 may also be advantageously configured to support an optimal flow of the LVB solution. A brine return system is configured to recover a return solution (“unused brine”) and return the unused brine back to the storage tank and/or injector for reuse. Often the unused brine contains particles resulting from the injection process, which can clog the needles. Conventional return systems remove these particles with a filter or separator in the storage tank. However, such filters and separators are difficult to clean. Moreover, any discarded particles reduces the overall yield. Thus, the brine return system may instead be configured to reduce the particle size to form a reduced return solution suitable for reuse. For instance, the brine return system may incorporate one or more aspects of the system and method described in U.S. Pat. No. 7,645,472, entitled “Method for Recycling Liquids for Treating Food”, hereby incorporated by reference in its entirety.

The second cutting assembly 124 will now be generally described. The second cutting assembly 124 may be generally configured to cut, trim, and/or portion (optionally treated) workpieces in accordance with predetermined specifications for workpiece end products. Portioning and/or trimming of workpieces can be carried out by various cutting devices, including high-speed liquid jet cutters (liquids may include, for example, water or liquid nitrogen), rotary blades, reciprocating blades, etc., after the workpieces are transferred from an infeed to a cutting conveyor.

The second cutting assembly 124 may be configured as a high-speed portioner or portioning machine, such as the exemplary machine shown in FIG. 5A. Some high-speed portioning machines, or portions thereof, are disclosed in prior patents, for example, U.S. Pat. Nos. 4,962,568, 5,868,056, 7,651,388, 10,751,902, and 11,883,974 and U.S. Pat. App. Pub. No. US20240033868A1, which are incorporated by reference herein. Typically, the workpieces are first carried by an infeed conveyor past a scanning station (e.g., part of the sensor assembly 116), where the workpieces are scanned to ascertain selected physical characteristics, for example, their size and shape, and then to determine their weight, typically by utilizing an assumed density for the workpieces. In addition, it is possible to locate discontinuities (including voids), foreign material, and undesirable material in the workpiece, for example, bones or fat in a meat portion. The data and information measured/gathered by the scanning devices are transmitted to a computer, such as the processing computing device 132, which records the location of the workpiece on the conveyor as well as the shape and other characteristics of the workpiece. With this information, the computer determines how to optimally cut or portion the workpiece at the second cutting assembly 124, and the portioning may be carried out by various types of cutting/portioning devices.

In many high-speed portioning systems, several high-speed waterjet cutters are positioned along the length of a conveyor to achieve high throughput of the portioned/cut workpieces. If a waterjet cutter is used to portion or trim the workpiece, it is advantageous to utilize an open mesh, metallic belt to allow the waterjet to pass downwardly therethrough, and also so that the belt is of sufficient structural integrity to withstand the impact thereon from the waterjet. Such metallic, open mesh belts are articles of commerce.

The harvesting assembly 126 and secondary processing assembly 128 will now be generally described. Generally, the harvesting assembly 126 may be configured to sort and/or pickup workpieces of various sizes for further processing or packaging by the secondary processing assembly 128. The harvesting assembly 126 may incorporate suitable mechanical structure for sorting and picking up workpieces, such as air sorters, paddles, robots with end effectors, suction nozzles, drop conveyors, etc. In one example, the harvesting assembly 126 may incorporate aspects of the systems and methods described in U.S. Pat. No. 11,883,974, entitled “Pick and Throw Harvesting”, incorporated by reference herein in its entirety and as shown in FIG. 5B.

For example, if the workpiece is portioned into pieces, the processing computing device 132 may instruct the harvesting assembly 126 to remove or divert trim pieces or other unwanted pieces from the conveyor (based on, for instance, their known location on the conveyor resulting from the cutting instructions, data sent from the sensor assembly 116 and/or the processing computing device 132 indicating that the incoming product was not the correct shape/size/type to produce certain portions, etc.). The trim may be diverted to collection bins, totes, etc., for reuse (e.g., secondary processing) and/or for supplying to the treatment solution assembly 122 for treatment solution formulation.

In some examples, the processing computing device 132 may instruct the harvesting assembly 126 to transfer all portions of a certain type to a designated conveyor, bin, etc., for secondary processing together. For instance, after any primary processing (e.g., cutting, portioning, trimming, etc.), the workpiece (and/or any material removed from the workpiece) may be transferred to a takeaway conveyor, a storage bin, a packager, or other location, such as with a pick-up station. The pick-up station, sorter, and packager may receive instructions from the processing computing device 132.

In some examples, the treatment solution assembly 122 may be located after the harvesting assembly 126 and before the secondary processing assembly 128. In that regard, the workpieces may be cut/portioned/trimmed by the second cutting assembly 124 before application of the treatment solution. After being cut/portioned/trimmed by the second cutting assembly 124, the workpieces may move to the treatment solution assembly 122 for application of a treatment solution (e.g., by injection). Such a system layout and workpiece flow path can optimize trim use because substantially no treated trim is produced by the second cutting assembly 124.

However, application of a treatment solution before cutting/portioning/trimming by the second cutting assembly 124 may be preferred. If treatment solution is applied before cutting/portioning/trimming, the approximate or predicted end weight of the cut/portioned/trimmed workpiece, which includes the treatment solution, is known. Moreover, certain cut/portioned/trimmed workpieces, such as nuggets, are difficult to inject. Accordingly, injecting or applying a treatment solution before cutting/portioning/trimming by the second cutting assembly 124 may be preferred.

The secondary processing assembly 128 may include suitable components, machines, or assemblies configured to perform any necessary secondary processing of the workpieces and/or trim. Secondary processing assemblies may include breaders, fryers, ovens, freezers, packagers, etc. Multiple conveyors or lanes may be used to move workpieces to one of various secondary processing assemblies, depending on their end use.

In that regard, a third sorting assembly 118c may be located downstream of the harvesting assembly 126 and upstream of the secondary processing assembly 128 for sorting or diverting workpieces into an appropriate lane or channel of the secondary processing assembly 128. For instance, workpieces having a first thickness (e.g., dinner portion size) may be diverted to a breader of the secondary processing assembly 128, whereas workpieces having a second thickness (e.g., a double breakfast portion size) may be diverted to a horizontal slicer of the secondary processing assembly 128 for slicing the workpiece into two portions.

The schematic illustration of FIG. 2 depicts the exemplary components of the workpiece processing system 104 arranged in-line or relative to a processing line of the workpiece processing system 104 to facilitate workpiece processing and trim optimization. It should be appreciated that any suitable combination of workpiece processing system components, whether in-line or as a separate batch components or subassemblies, may be used to facilitate workpiece processing and trim optimization. Moreover, the assemblies shown in FIGS. 3-6 are for illustrative purposes only and should not be seen as limiting.

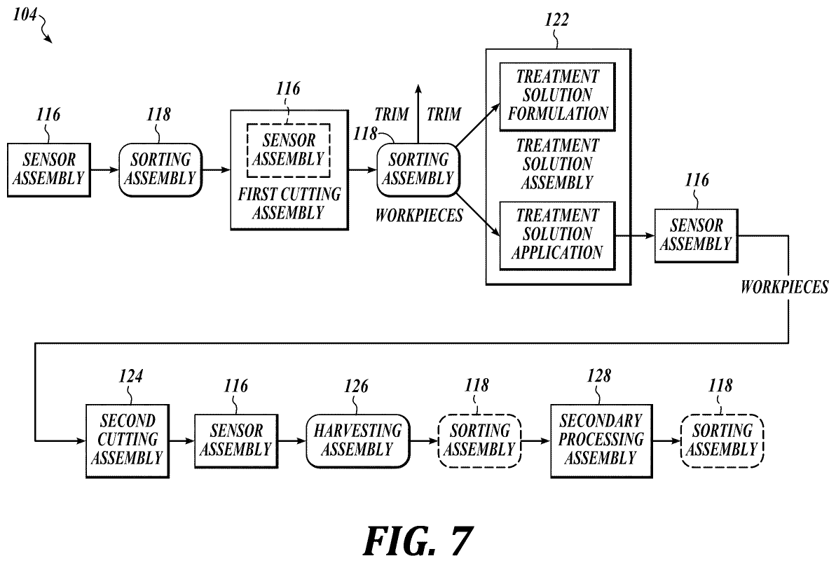

FIG. 7 illustrates an exemplary layout and workpiece flow path for a workpiece processing system 104. The workpiece flow path may be defined using components shown and described with reference to FIGS. 1 and 2. To start, incoming workpieces pass a portion of sensor assembly 116, such as a vision system. Based the results of scanning, classified incoming workpieces are diverted by sorting assembly 118 to a portion of the first cutting assembly 120. For instance, workpieces having a first thickness or weight may be diverted to a first slicer of first cutting assembly 120, whereas workpieces having a second thickness or weight may be diverted to a second slicer of first cutting assembly 120.

One or more of the slicers of the first cutting assembly 120 may be manually or automatically adjusted to slice workpieces at different thickness or heights, such as in response to sensor data captured by a portion of sensor assembly 116. For instance, as noted above, vision sensor data from a slicer of the first cutting assembly 120 and/or a portioner of the second cutting assembly 124 may be used to capture workpiece data before and/or after the workpiece is sliced by first cutting assembly 120.

Sliced (and optionally vertically cut) workpieces and resulting trim may pass by a portion of sorting assembly 118, which may divert trim for use in treatment solution formulation of the treatment solution assembly 122 and/or other use (e.g., secondary processing). A portion of the sensor assembly 116, such as a weigh station, may be used to determine an amount of trim generated by the first cutting assembly 120 and/or an amount of trim diverted to the treatment solution assembly 122.

Sorting assembly 118 may also divert sliced workpieces to the treatment solution assembly 122 for treatment solution application, such as by injection. In some examples, workpieces having a first thickness or weight may be treated separately from workpieces having a second thickness or weight. In some examples, the sliced workpieces are not treated and are diverted from the first cutting assembly 120 to a next portion of the workpiece processing system 104.

Treated (or optionally non-treated), sliced (and optionally cut) workpieces (optionally separated by classification, such as thickness or weight) pass by a portion of sensor assembly 116, such as a vision system, which gathers workpiece sensor data for defining cut paths for the second cutting assembly 124, such as based on workpiece physical characteristics and end product specifications and requirements. For example, the processing computing device 132 may use the workpiece sensor data to define cut paths for generating an optimal number or combination of portions from the respective workpiece.

The treated, sliced (and optionally cut), portioned workpieces and any resulting trim are sorted by harvesting assembly 126 before moving to the secondary processing assembly 128. For instance, workpieces of a first type may be removed from the conveyance assembly 130 for a first type of secondary processing by the secondary processing assembly 128, workpieces of a second type may be left on the conveyance assembly 130 for a second type of secondary processing by the secondary processing assembly 128, and trim may be removed from the conveyance assembly 130 for a third type of secondary processing. Secondary processing of a first type may include breading, thermal processing (frying, cooking, freezing, etc.), packaging, etc. Secondary processing of a second type may include horizontal slicing, and then breading, thermal processing (frying, cooking, freezing, etc.), packaging, etc. Secondary processing of a third type may include packaging/resale, grinding, etc.

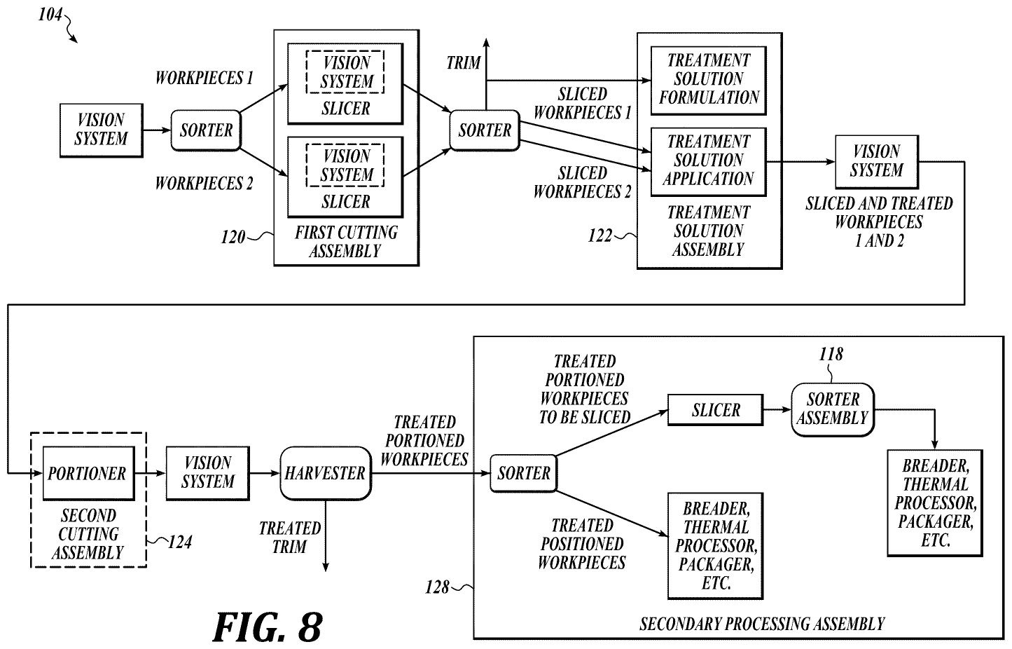

A specific example of an exemplary layout and workpiece flow path for a workpiece processing system 104 will now be described with reference to FIG. 8. The workpiece flow path may represent various processing steps that may occur for a trimmed, sub-primal product, such as chicken breast fillets. The workpiece flow path may be defined using components shown and described with reference to FIGS. 1 and 2.

To start, incoming workpieces pass a portion of a sensor assembly 116, such as a vision system. Based on the results of scanning, classified incoming workpieces, such as workpieces 1 and 2 are diverted by sorting assembly 118 to a portion of the first cutting assembly 120. For instance, workpieces 1 may have a first thickness or weight and may be diverted to a first slicer of first cutting assembly 120, whereas workpieces 2 may have a second thickness or weight greater than the first thickness or weight and may be diverted to a second slicer of first cutting assembly 120. In that regard, workpieces 1 may be sliced to a first height suitable for a required end product (e.g., sandwich portion), and workpieces 2 may be sliced to a second height suitable for a double portion of a required end product (e.g., breakfast portion). One or more of the slicers of first cutting assembly 120 may receive sensor data from a sensor assembly 116, such as a vision system, for automatically or manually adjusting the horizontal slice location depending on workpiece characteristics, such as thickness or weight.

Sliced workpieces 1 and 2 and resulting trim may pass by a portion of sorting assembly 118, which may divert trim to the trim use assembly for use in treatment solution formulation of the treatment solution assembly 122 and/or other use (e.g., secondary processing). In some examples, a weight measurement of some or all of the diverted trim may be taken after being diverted to the treatment solution assembly 122 and/or another portion of the trim use assembly.

Sorting assembly 118 may divert sliced workpieces 1 and 2 to the treatment solution assembly 122 for treatment solution application, such as by injection. In some examples, workpieces 1 and 2 may be treated separately for sorting purposes. In some examples, the sliced workpieces are not treated and are diverted from the first cutting assembly 120 to a next portion of the workpiece processing system 104.

Treated (or optionally non-treated), sliced workpieces 1 and 2 (optionally separated) pass by a portion of sensor assembly 116, such as a vision system, which gathers workpiece sensor data for defining portioner cut paths for the second cutting assembly 124, such as based on end product specifications and requirements. For example, the processing computing device 132 may use the workpiece sensor data to define cut paths for generating an optimal number or combination of portions from the respective workpiece. For workpieces 1, the cut paths may define end products suitable for the first thickness or weight (e.g., sandwich portions, chicken strips, chicken nuggets, etc.). For workpieces 2, the cut paths may define end products suitable for the second thickness or weight (e.g., double breakfast portions, chicken strips, chicken nuggets, etc.). In some examples, sensor data from the vision system associated with second cutting assembly 124 is processed by the processing computing device 132, which outputs corresponding instructions for adjusting a slicer of the first cutting assembly 120.

The treated, sliced, portioned workpieces 1 and 2 (optionally separated) and any resulting treated trim are sorted by harvesting assembly 126 before moving to the secondary processing assembly 128. For instance, workpieces of a first type may be removed from the conveyance assembly 130 for a first type of secondary processing by the secondary processing assembly 128, workpieces of a second type may be left on the conveyance assembly 130 for a second type of secondary processing by the secondary processing assembly 128, and treated trim may be removed from the conveyance assembly 130 and diverted for use in a third type of secondary processing by the secondary processing assembly 128 (e.g., such as for packaging/resale or other secondary processing). Workpieces having defects (e.g., blood spots, bruises, poor shapes, woody chicken, etc.) may also be removed and diverted for secondary processing.

For example, the treated, sliced, portioned workpieces of a first type, such as chicken nuggets and strips, sandwich portions, etc., may be diverted to a breader, thermal processor (fryer, oven, freezer, etc.), and/or packager. The treated, sliced, portioned workpieces of a second type, such as double thickness portions, may be diverted to a horizontal slicer for slicing the double portion into two portions.

The sliced portions may then pass through a portion of the sorting assembly 118 for diverting different types of sliced workpieces to different locations. For instance, a first type or volume of sliced portions (e.g., breakfast portions) may be diverted to a first portion of the secondary processing assembly 128 (e.g., a first breader). A second type or volume of sliced portions (e.g., breaded lunch portions) may be diverted to a second portion of the secondary processing assembly 128 (e.g., a second breader or a collection bin destined for the first breader). A third type or volume of sliced portions (e.g., grilled lunch portions) may be diverted to a third portion of the secondary processing assembly 128 (e.g., an oven). Defective sliced portions (e.g., portions skipped over during slicing, portions that are the incorrect thickness, shape, or size, etc.) may be diverted to a collection bin, etc. Some or all of the sliced workpieces may thereafter be moved to additional secondary processing components, such as thermal processing (frying, cooking, freezing, etc.), packaging, etc.

Another specific example of an exemplary layout and workpiece flow path for a workpiece processing system 104 will now be described with reference to FIG. 9. The layout and workpiece flow path of FIG. 9 may represent various processing steps that may occur for an untrimmed, sub-primal product, such as chicken breast butterflies. The workpiece flow path may be defined using components shown and described with reference to FIGS. 1 and 2. Moreover, the exemplary layout and workpiece flow path may be substantially similar to the exemplary layout and workpiece flow path shown in FIG. 8 and described above, with the exception of the first cutting steps carried out by the first cutting assembly 120. Thus, only the first cutting steps carried out by the first cutting assembly 120 and the resultant overall differences will be described in detail.

To start, incoming workpieces pass a portion of a sensor assembly 116, such as a vision system. Based on the results of scanning, classified incoming workpieces, such as workpieces 1 and 2 are diverted by sorting assembly 118 to a portion of the first cutting assembly 120. For instance, workpieces 1 may have a first thickness or weight and may be diverted to a first slicer of first cutting assembly 120, whereas workpieces 2 may have a second thickness or weight greater than the first thickness or weight and may be diverted to a second slicer of first cutting assembly 120. In that regard, workpieces 1 may be sliced to a first height suitable for a required end product (e.g., sandwich portion), and workpieces 2 may be sliced to a second height suitable for a double portion of a required end product (e.g., breakfast portion). One or more of the slicers of first cutting assembly 120 may receive sensor data from a sensor assembly 116, such as a vision system, for automatically or manually adjusting the horizontal slice location depending on workpiece characteristics, such as thickness or weight.

Sliced workpieces 1 and 2 (e.g., chicken butterflies) and resulting untreated trim may pass by a portion of sorting assembly 118, which may divert untreated trim to the trim use assembly for use in treatment solution formulation of the treatment solution assembly 122 and/or other use (e.g., resale for other products). In some examples, a weight measurement of some or all of the diverted trim may be taken after being diverted to the treatment solution assembly 122 and/or another portion of the trim use assembly.

Sorting assembly 118 may divert sliced workpieces 1 and 2 to first and second portioners of the first cutting assembly 120, or first and second lanes of a single portioner. The portioner(s) may incorporate a sensor assembly, such as a vision system, to gather workpiece sensor data. The workpiece sensor data may be used to define portioner cut paths for each workpiece, such as based on workpiece trim specifications and requirements. For example, the processing computing device 132 may use the workpiece sensor data to define cut paths for trimming the workpiece (e.g., chicken butterfly), to an optimal fillet shape and size for later generating end products. In some examples, sensor data from the vision system associated with a portioner of the first cutting assembly 120 is processed by the processing computing device 132, which outputs corresponding instructions for adjusting a slicer of the first cutting assembly 120.

Sorting assembly 118 may again divert untreated trim generated by the portioner to the trim use assembly of the treatment solution assembly 122 for use in treatment solution formulation and/or to another location for other use (e.g., secondary processing). Sorting assembly 118 may divert sliced and trimmed workpieces 1 and 2 to the treatment solution assembly 122 for treatment solution application, such as by injection. In some examples, workpieces 1 and 2 may be treated separately for sorting purposes. In some examples, the sliced workpieces are not treated and are diverted from the first cutting assembly 120 to a next portion of the workpiece processing system 104.

As discuss above with respect to FIG. 8, treated (or optionally non-treated), sliced and portioned workpieces 1 and 2 (optionally separated) move to the second cutting assembly 124, such as a portioner, after passing a vision system to gather workpiece sensor data for defining portioner cut paths. The treated, sliced, portioned workpieces 1 and 2 (optionally separated) and any resulting treated trim may then be sorted by harvesting assembly 126 before moving to the secondary processing assembly 128.

Using a high-speed portioner in the first cutting assembly 120 for preliminary trimming of the workpieces, as shown in FIG. 9, minimizes the volume of treated trim produced during workpiece processing. If butterflies or a similar type of workpiece were treated without first being trimmed, a significant volume of treated trim would be generated during portioning/trimming at the second cutting assembly 124. Thus, by using the systems and methods described herein to process chicken butterflies or the like, such as using the exemplary layout and workpiece flow path shown in FIG. 9, trim use is optimized. It should be appreciated that in some examples, the workpieces may first be portioned by a portioner of the first cutting assembly 120 and then sliced by a slicer of the first cutting assembly 120.

It can also be appreciated from the descriptions provided herein that the workpiece processing optimization system 102 (as partially shown in in FIG. 8, 9, 10, or similar), enables a treatment solution to be formulated with trim or workpieces at the location of the workpiece processing system 104. The trim can be produced at the first cutting assembly 120 and diverted to the treatment solution assembly 122 for treatment solution production. Moreover, using the systems and techniques described in U.S. Provisional Patent Application Nos. 83/617,897, incorporated herein, a treatment solution can be formulated using simple techniques and limited ingredients, supporting onsite production.

Onsite treatment solution production provides several benefits. For instance, by producing treatment solutions onsite, trim production and use can be more closely managed and optimized. The cost associated with storage, shipping, etc., of off-site trim can be avoided. Moreover, the amount of trim generated by the workpiece processing system 104 can be adjusted to support production of a treatment solution for the workpieces, as will be described further below.

Operators and customers can also control the source of trim used for the solution, which can aid in product labeling (knowing the ingredients and/or source) and traceability efforts. The treatment solution produced from trim can be used to treat the workpieces of that same batch, production run, clean break shift, etc. In that regard, any contamination or other issues causing a recall is limited to that batch, production run, clean break shift, etc. In order to support a clean break schedule, some of the raw, incoming supply of workpieces (e.g., untrimmed/uncut) can be used to produce an initial supply of treatment solution for treating the initial incoming supply of workpieces.

Onsite treatment solution production can also minimize variability among treated workpieces. For instance, using on-site trim can ensure that the treatment solution includes raw ingredients of generally the same level of freshness. Raw food products continuously change in consistency after slaughter. Thus, to minimize variability among treated workpieces (e.g., yield, texture, taste, bite), the freshness level or age of the raw material, or trim, used to produce the treatment solution may be controlled.

For instance, if the trim is always generated from 2-day-old chicken breast fillets or butterflies (or 2 days after slaughter), and the treatment solution produced from that trim is used to treat the trimmed chicken breast fillets or butterflies on that same day or within a specified period, the finished chicken workpieces will have consistent treatment effects (e.g., yield, texture, taste, bite). In that regard, the systems and method described herein may be used to minimize variability among treated workpieces by generating trim within a designated time after slaughter, using trim to produce a treatment solution within a designated time after slaughter, and treating a certain type of workpieces with that solution within a designated time after slaughter.

Moreover, using the systems and techniques described in U.S. Provisional Patent Application Nos. 83/617,897 and ______, incorporated herein, the treatment solution can be formulated and injected using low shear techniques, which preserves the quality of the emulsified trim or protein in the treatment solution. For instance, the treatment solution can be supplied to the injector via a low shear system (e.g., a diaphragm pump and simple valving), the trim can be injected with a top port manifold carrier that minimizes shear on the treatment solution, and the used treatment solution can be returned to the supply by a return system that gently emulsifies larger particles and preserves the nature of the solution. By contrast, if the various components of the injection system induce shear on the treatment solution, portions of the solution can denature or otherwise change in composition, affecting treatment results.

The consistency in treated workpieces provided by an onsite treatment solution production, such as that described herein, can support the use of machine learning models trained and used to optimize the production of trim and the use of trim. If the source and freshness of the trim is known, the machine learning models can more easily be trained and implemented. For instance, data regarding workpiece yield can be correlated to slicing thickness at the first cutting assembly 120 without requiring correlation to trim source or freshness level. Such benefits will become further appreciated when discussing exemplary machine learning models herein.

As noted above, the various components of the workpiece processing system 104 may be managed by the processing computing device 132. More specifically, the processing computing device 132 may be configured to manage at least some of the workpiece processing steps, such as conveying, sorting, slicing, treating, cutting (e.g., portioning, slicing, trimming), harvesting, packaging, etc. The processing computing device 132 may instruct one or more components of the sorting assembly 118, the first cutting assembly 120, the treatment solution assembly 122, the second cutting assembly 124, the harvesting assembly 126, and the secondary processing assembly 128 to process a workpiece in accordance with customer specifications based on various physical parameters of the workpiece, as determined from the sensor data.

Exemplary aspects of the processing computing device 132 will now be described with reference to FIG. 10. In the exemplary block diagram of FIG. 10, the processing computing device 132 includes a processor(s) 1108, a communication interface(s) 1110, computer readable medium 1112, and at least one data store 1120. As shown, the computer readable medium 1112 has stored thereon logic that, in response to execution by the one or more processor(s) 1108, cause the processing computing device 132 to provide a sensor data processing engine 1114, a model generation engine 1116, and a workpiece processing engine 1118.

The processing computing device 132 may be implemented by any computing device or collection of computing devices, including but not limited to a desktop computing device, a laptop computing device, a mobile computing device, an edge computing device, a server computing device, a computing device of a cloud computing system, and/or combinations thereof. In some examples, the processor(s) 1108 may include any suitable type of general-purpose computer processor. In some examples, the processor(s) 1108 may include one or more special-purpose computer processors or AI accelerators optimized for specific computing tasks, including but not limited to graphical processing units (GPUs), vision processing units (VPTs), and tensor processing units (TPUs).

In some examples, the communication interface(s) 1110 includes one or more hardware and or software interfaces suitable for providing communication links between components. The communication interface(s) 1110 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, “engine” refers to logic embodied in hardware or software instructions, which can be written in one or more programming languages, including but not limited to C, C++, C #, COBOL, JAVA™, PHP, Perl, HTML, CSS, Javascript, VBScript, ASPX, Go, and Python. An engine may be compiled into executable programs or written in interpreted programming languages. Software engines may be callable from other engines or from themselves. Generally, the engines described herein refer to logical modules that can be merged with other engines or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

The sensor data processing engine 1114 of the processor computing device 132 may be configured to process incoming sensor data for a workpiece and/or trim (herein sometimes simply “workpiece”). The sensor data may include one or more images captured by the sensor assembly 116. For instance, the sensor data may include one or more images generated by the x-ray apparatus 117 and the optical scanner 119.

The sensor data processing engine 1114 may be generally configured for generating sensor data for a workpiece and/or trim and outputting that sensor data (after any pre-processing) to another engine or module of the processing computing device 132 and/or another computing device of the workpiece processing optimization system 102, such as the trim optimization computing device 106 and/or data processing computing device 107. In that regard, the sensor data processing engine 1210 may be configured to execute one or more feature recognition modules for generating views/images from the scan data and/or processing data from the different views. For instance, as noted above, the sensor data processing engine 1114 may be configured to generate at least one of a fat recognition (FRS) object view, a laser scatter object view, and a height mode object view, such as from data captured with the optical scanner 119.

Before executing one or more feature recognition modules, the sensor data processing engine 1210 may first analyze the data from the X-ray apparatus 117 and the optical scanner 121 to confirm that a workpiece scanned by the optical scanner 121 is the same as a workpiece previously scanned by X-ray apparatus 117 and/or whether the workpiece has moved or shifted during transfer between conveyors, as discussed in U.S. Pat. Nos. 10,654,185 and 10,721,947 (referenced above), incorporated by reference herein. In that regard, a comparison of the X-ray and optical data may be processed by the processor computing device 132.

The sensor data processing engine 1210 may be configured to generate a registered scan of a workpiece including a first scan of a first scan type (e.g., x-ray) and a second scan of a second scan type (e.g., an optical image). For instance, a registered scan of the workpiece may be generated by the sensor data processing engine 1210, which maps an X-ray image of the workpiece scanned at the x-ray apparatus 117 onto a (possibly transformed) optical image of the workpiece as scanned by optical scanner 119. In one example, the registered scan is generated by the sensor data processing engine 1210 using the systems and methods described in U.S. Pat. No. 10,654,185, incorporated herein by reference in its entirety. For instance, the X-ray data may be mapped onto the optical data, optionally with a transformation or translation of one or more of the images/data to account for any movement/shifting of the workpiece on a conveyor.

Data processed by the sensor data processing engine 1210 may be transmitted to or retrieved by the model generation engine 1116 for generating one or more of a 2D and 3D model of the scanned workpiece and/or trim. The model generation engine 1116 may include software modules suitable for processing scan data and generating 3D models (showing contour, shape, volume, texture, etc.), 2D models (e.g., showing a height and outline), or other images. For instance, the model generation engine 1116 may run the proprietary DSI Q-LINK™ Portioning Software developed by Design Systems, Inc. of Redmond, Washington.

The model generation engine 1116 may execute one or more feature recognition modules for generating 2D views/images/models from the scan data. The one or more feature recognition modules may be executed by the model generation engine 1116 in addition to or instead of execution by the sensor data processing engine 1210. For instance, the model generation engine 1116 may be configured to generate at least one of a fat recognition (FRS) object view, a laser scatter object view, and a height mode object view. A 2D model of a workpiece may be used to identify a contour of a workpiece, shape irregularities of the workpiece, height, etc.

The model generation engine 1116 may also or instead be configured to generate 3D models of a scanned workpiece. A 3D model of the workpiece may be used to determine how to cut the workpiece into desired portions and/or trim the workpiece into a desired overall shape.

The cutting, portioning, trimming, etc., of a food product may be carried out by the workpiece processing engine 1118 of the processing computing device 132. The workpiece processing engine 1118 may analyze data received from the sensor data processing engine 1114 and/or the model generation engine 1116 to determine cut paths for the first cutting assembly 120 and/or the second cutting assembly 124 as well as other processing steps (e.g., sorting, picking, harvesting, etc.).

The workpiece processing engine 1118 may be configured to process output received from the data processing computing device 107 to manage processing aspects of the workpiece. The data processing computing device 107 may train and/or run various machine learning modules suitable for analyzing sensor data pertaining to workpieces (e.g., received from the sensor data processing engine 1114) for optimizing workpiece processing. For instance, the data processing computing device 107 may run one or more of the machine learning modules described in U.S. Provisional Patent No. 63/588,917, incorporated by reference herein in its entirety.

The machine learning models, as is typical, may require significant processing power and capacity. Moreover, as processing needs change or as machine learning models are improved, it can be appreciated that the ability to easily access, update, and/or upgrade a separate computing device for use with the processing computing device 132 and optionally one or more additional processing systems in a facility would be beneficial. In that regard, it may be beneficial to configure aspects of the data processing computing device 107 as a local, high power or edge computing device separate from the processing computing device 132, such as the data processing computing device described in U.S. Provisional Patent No. 63/588,917. However, it should be appreciated that in some examples, the data processing computing device 107 and the processing computing device 132 (and any other computing device of the workpiece processing optimization system 102) may be integrated into one or more computing devices.

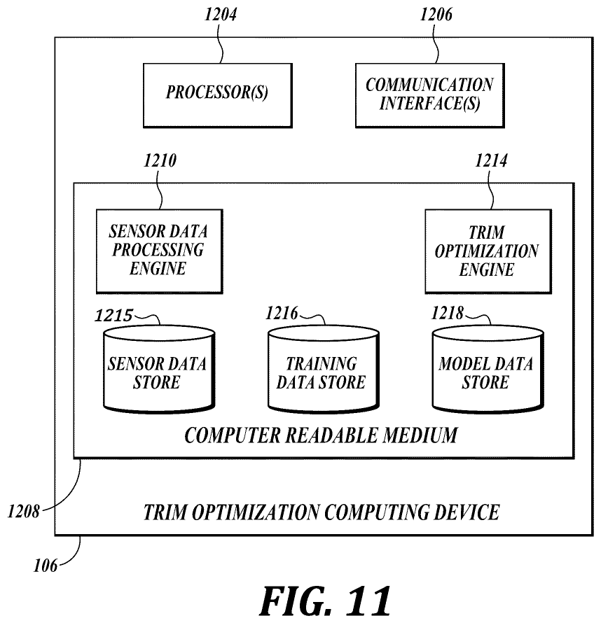

The workpiece processing engine 1118 may also receive/process instructions from the trim optimization computing device 106 to make any necessary cutting or processing adjustments to optimize processing and/or trim production and use. Exemplary aspects of the trim optimization computing device 106 will now be described with reference to the exemplary block diagram shown in FIG. 11.

The trim optimization computing device 106 may include a processor(s) 1104, a communication interface(s) 1206, computer readable medium 1208, and at least one data store such as a sensor data store 1210, a training data store 1216, and a model data store 1218. As shown, the computer readable medium 1208 has stored thereon logic that, in response to execution by the one or more processor(s) 1204, cause the trim optimization computing device 106 to provide a sensor data processing engine 1210, and a trim optimization engine 1214. As discussed above with the processing computing device 132, the trim optimization computing device 106 may be implemented by any computing device or collection of computing devices. Moreover, any suitable processor(s) and communication interface(s) may be used.

The sensor data processing engine 1210 of the trim optimization computing device 106 may be configured to process incoming sensor data for a workpiece and/or trim and store any data in the sensor data processing engine 1210. For instance, the sensor data may include one or more images captured by the sensor assembly 116. The image sensor data may be pre-processed by the sensor data processing engine 1114 of the processing computing device 132. In that regard, the sensor data may include 2D and/or 3D models of the workpieces and/or trim. The sensor data may also or instead include workpiece and/or trim physical characteristics determined by the sensor data processing engine 1114 and/or the data processing computing device 107 based on the sensor data, such as its thickness, thickness profile, contour, outer contour configuration, perimeter, outer perimeter configuration, outer perimeter size and/or shape, volume, mass, and weight, fat content, as well as other aspects of the physical parameters/characteristics of the workpiece. The sensor data may also or instead include weight measurement data, temperature data, etc.

In some examples, the sensor data includes weight data of workpieces and/or trim at various locations along the path of workpiece processing, such as determined by image sensor data and/or weight measurement sensor data. For instance, weight data of workpieces and/or trim may be determined before and/or after horizontal cutting by a slicer of the first cutting assembly 120, before and/or after vertical cutting by a portioner of the first cutting assembly 120, before being used for treatment solution production at the trim use assembly, before and/or after cutting by a portioner or other cutting machine of the second cutting assembly 124, etc. In some examples, the sensor data includes temperature data of workpieces and/or trim before, during, and/or after use or treatment at the treatment solution assembly 122.

Workpiece and/or trim sensor data can be used by the trim optimization engine 1214 to optimize trim production and trim end use designation. For instance, the trim optimization engine 1214 may be generally configured to execute a workpiece organization algorithm to generate a trim optimization plan for managing aspects of the workpiece processing to optimize trim production and use. The trim optimization plan may include instructions for the workpiece processing engine 1118 of the processing computing device 132 for managing aspects of the workpiece processing to optimize trim production and use. The instructions of the trim optimization plan may also or instead include a recommendation(s) for component or machine setting adjustments to optimize trim production and use, such as for carrying out by an operator.

Execution of the workpiece organization algorithm may include analyzing workpiece and/or trim sensor data, including 2D and/or 3D models, an FRS object view, or other image data generated by the processing computing device 132, output data of the data processing computing device 107, temperature data, and any associated weight data. The workpiece and/or trim sensor data may be analyzed in view of workpiece supply, finished workpiece demand, workpiece processing requirements, trim demand (e.g., trim required to make a treatment solution, trim needed for secondary processing, target trim fat content, etc.), treatment solution temperature requirements, etc.

In some examples, the workpiece organization algorithm may analyze workpiece and/or trim weight data to determine if the volume of untreated trim generated by the first cutting assembly 120 is sufficient to produce a treatment solution at the treatment solution assembly 122 and/or to produce a required volume of trim for a secondary processing (e.g., resale). If the trim level is insufficient, the trim optimization plan may include instructions for generating more trim at the first cutting assembly 120, such as by slicing a greater amount of trim with a slicer, generating more trim with a portioner, etc.

The instructions may include designating a certain type of workpiece (e.g., workpiece 1 having a thickness greater or less than workpiece 2 or a shape/size different than workpiece 2) for slicing at a certain thickness or portioning in a specified manner. As an example, if workpieces 1 have a thickness greater than workpieces 2, it may be optimal to slice more trim from workpieces 1 if there is a sufficient amount of workpieces 1 to generate desired end products, such as double portion workpieces. The type of workpiece may be selected based on workpiece supply data from a raw workpiece supply/demand engine 134 of the workpiece utilization computing device 110 and using an external order filling techniques, such as that described in U.S. Pat. Nos. 7,672,752 and 8,688,267, incorporated by reference herein in their entirety. For instance, if an incoming supply of the workpiece type exceeds a threshold volume needed to produce desired end products, the workpiece type may be ideal for slicing at a certain thickness or portioning to a certain size or shape to generate a certain amount of trim.

In some cases, generating more trim at the slicer or portioner of the first cutting assembly 120 may not be optimal. For instance, if a greater percentage of a workpiece is sliced or trimmed from the workpiece, it may compromise the thickness or shape of the workpiece required for the finished end product. As such, the trim optimization plan may include instructions for generating more trim using a portion of the incoming supply of workpieces. For instance, whole chicken breast butterflies or fillets may be used to produce the treatment solution. In that regard, the trim optimization plan may include instructions to the sorting assembly 118 to divert a portion of an untrimmed, incoming supply of workpieces to the treatment solution assembly 122 for use in producing a treatment solution.

If execution of the workpiece organization algorithm determines that the trim level exceeds the volume needed to produce a treatment solution, the trim optimization plan may include instructions for generating less trim at the first cutting assembly 120. For instance, the trim optimization plan may include providing instructions for slicing less trim with a slicer, generating less trim with a portioner, etc. The instructions may include designating a certain type of workpiece (e.g., workpiece 1 having a thickness greater or less than workpiece 2 or a shape/size different than workpiece 2) for slicing at a certain thickness or portioning in a specified manner. As an example, if workpieces 1 have a thickness greater than workpieces 2, it may be optimal to slice less trim from workpieces 1 if there is a sufficient amount of workpieces 1 to generate desired end products, such as double portion workpieces.

The type of workpiece may be selected based on workpiece supply data from a raw workpiece supply/demand engine 134 of the workpiece utilization computing device 110 and using external order filling techniques, such as that described in U.S. Pat. Nos. 7,672,752 and 8,688,267, incorporated herein. For instance, if an incoming supply of the workpiece type exceeds a threshold volume needed to produce desired end products, the workpiece type may be ideal for slicing at a certain thickness or portioning to a certain size or shape to decrease the amount of trim.

In some cases, generating less trim at the slicer or portioner of the first cutting assembly 120 may not be optimal. For instance, if a lower percentage of each of the workpieces is sliced or trimmed from the workpieces, it may compromise the thickness or shape of the workpieces required for the finished end product. As such, the trim optimization plan may include designating an optimal end use for untreated trim, such as based on information received from a finished workpiece/trim supply/demand engine 136 of the workpiece utilization computing device 110. In that regard, the trim optimization plan may include providing instructions to the sorting assembly 118 to divert a portion of workpiece trim to a collection bin, conveyor, etc., such as for secondary processing.

In some examples, information from the finished workpiece/trim supply/demand engine 136 may be used to support order filling requirements of finished workpieces (“external orders”) and untreated trim (“internal orders”). For instance, the trim optimization plan may include providing instructions for generating trim to meet internal orders, such as for use in producing a treatment solution or for use in secondary processing (e.g., producing a finished workpiece (e.g., nuggets), resale, etc.)

The internal orders for trim may be based on the amount of trim needed to produce a treatment solution for an external order of finished workpieces. As external orders for finished workpieces change, the demand for trim needed to generate treatment solution for the workpieces would also necessarily change. In that regard, the trim optimization plan may include instructions to generate more or less trim at the first cutting assembly 120 to accommodate the changes in finished workpiece demand. The internal orders for trim may be based on the target fat content of the trim to produce a treatment solution. In that regard, the trim optimization plan may include instructions to generate higher or lower fat content trim at the first cutting assembly 120.

The instructions provided by the trim optimization engine 1214 regarding internal order filling may include techniques similar to those used to meet production goals for different piece portions of a workpiece (e.g., sandwich portions v. nuggets), such as those described in U.S. Pat. Nos. 7,672,752 and 8,688,267, incorporated herein. In that regard, the processing computing device 132 and/or the data processing computing device 107 may be configured to execute one or more algorithms for external order filling like that described in U.S. Pat. Nos. 7,672,752 and 8,688,267.

In some examples, the workpiece organization algorithm may analyze workpiece and/or trim fat content data to determine if the fat content level of untreated trim generated by the first cutting assembly 120 is above or below a target fat content level for producing a treatment solution at the treatment solution assembly 122. If the trim fat level is not at the target level, the trim optimization plan may include instructions for cutting workpieces with a different cut path (e.g., with a vertical cutter) at the first cutting assembly 120 to generate trim having a higher or lower fat content. If the trim fat level is not at the target level, the trim optimization plan may also or instead include instructions for cutting a different type of workpiece (e.g., a thicker workpiece, a workpiece having certain fat content, etc.) at a first slicing height and a second type of workpiece (e.g., a thinner workpiece, a workpiece having lower fat content, etc.) at a second slicing height.

In some examples, the workpiece organization algorithm may analyze workpiece and/or trim temperature data to determine whether a workpiece and/or trim temperature is above or below a target temperature for producing a treatment solution at the treatment solution assembly 122. If the workpiece and/or trim temperature is above or below a target temperature, the trim optimization plan may include instructions for adjusting one or more temperature control devices of the workpiece processing optimization system 102 to raise or lower the temperature(s).

In some examples, the trim optimization engine 1214 (and/or the data processing computing device 107) may execute various machine learning models suitable for outputting a trim optimization plan. For example, the workpiece organization algorithm described above may be carried out by one or more trim optimization plan machine learning models. The one or more trim optimization plan machine learning models may output a trim optimization plan to the workpiece processing engine 1118 of the processing computing device 132 for adjusting or carrying out processing by the workpiece processing system 104. The one or more trim optimization plan machine learning models may also or instead output a trim optimization plan to a display associated with a computing device of the workpiece processing optimization system 102, such as the processing computing device 132, which includes a recommendation for adjusting or carrying out processing by the workpiece processing system 104.

Input data for the trim optimization plan machine learning model(s) may include workpiece and/or trim sensor data, order filling requirements of finished workpieces (“external orders”) and untreated trim (“internal orders”), workpiece type (e.g., chicken breast fillets v. butterflies), trim source, trim freshness level, workpiece thickness or size, workpiece processing specifications such as workpiece processing system requirements (e.g., slicer configurations, portioner settings, injector settings, treatment solution assembly requirements, etc.), etc. The input may be represented as a string of numerical (optionally time-series) data, as image data, or any other suitable format.

The trim optimization plan may include instructions for controlling, adjusting, or otherwise managing aspects of the workpiece processing system 104 to optimize trim production and use. For instance, the instructions may include machine adjustment setting changes, such as adjustments for a slicer or portioner of the first cutting assembly 120 to generate more or less trim or trim of a different fat content level, adjustments for a sorter or harvester for diverting workpieces and/or trim to a designated use (e.g., divert more or less trim to the treatment solution assembly 122 for treatment solution formulation depending on external order changes), temperature control adjustments, etc. The instructions may be specific to a workpiece processing line run, a processing shift, etc. The instructions may also or instead be displayed on an associated computing device, which may include a recommendation for adjusting or carrying out processing by the workpiece processing system 104.

In some examples, a trim optimization plan machine learning model may be configured to output a trim optimization score regarding the efficacy of trim optimization for the workpiece processing optimization system 102. The trim optimization score may be determined from sensor data of the workpieces and/or trim and/or other data. The primary organization assembly score may be indicative of trim optimization efficacy based on at least one of several categories. The categories may include workpiece yield data, excess untreated trim (e.g., per an internal order), volume or mass of treated trim, treatment solution effectiveness, etc. The categories and/or the score may be particular to the incoming workpiece specifications (e.g., type, thickness, size, etc.), finished workpiece specifications (percentage within spec, yield data, etc.), the finished workpiece type(s), the production line, a production shift, a clean break, etc. For instance, a trim optimization score may differ for chicken butterflies versus chicken breast fillets.

An individual trim optimization score may be provided as output for each category, and/or a cumulative trim optimization score may be provided based on some or all of the categories. In any event, a trim optimization score may be weighted depending on the importance of that category for workpiece processing, trim optimization, etc. For instance, in some examples, workpiece yield may be more important than treated and/or untreated excess trim. In such an example, the score for workpiece yield may have greater influence on the final or cumulative trim optimization score.

A trim optimization score may be based at least in part on numerical data, such as from a comparison of workpiece sensor data gathered by the workpiece processing system 104 to reference target values. For instance, a numerical value may be assigned as a score and/or may be used to generate a score for a category based on a calculated difference between a measured value (e.g., workpiece yield) and a target value. A trim optimization score may be based at least in part on time series data, such as external order and/or internal order data, workpiece processing system settings (e.g., slicer configurations, portioner settings, injector settings, etc.), workpiece and/or trim weight data at various locations in the workpiece and trim flow path, etc., recorded over consistent intervals of time.

In some examples, the trim optimization machine learning model(s) may output a trim optimization score(s) to the data processing computing device 107, which may use the score as input when executing another machine learning model. For instance, the score(s) may be used as input for a trim optimization machine learning model that is trained using trim optimization score(s), as described just above. Such a trim optimization machine learning model may output a trim optimization plan based on the trim optimization score(s) and any other relevant data (e.g., workpiece specifications, workpiece yield, first cutting assembly 120 and/or second cutting assembly 124 settings, workpiece processing system requirements, treatment solution assembly 122 requirements, etc.) as input.

In some examples, the trim optimization machine learning model(s) may optimize a trim optimization plan based on various preferences, such as internal order filling (e.g., for sufficient and/or effective treatment solution production), workpiece yield (e.g., preference for minimizing the needs to use uncut chicken breast fillets or butterflies to product treatment solution, preference for a certain amount of workpiece 1 v. 2), minimized excess trim production, clean break schedules, etc., such as per an operator or customer. For instance, a customer may have preferred adherence to producing a certain amount of finished workpieces (such as double portion pieces) over minimizing excess trim production. In such an instance, the trim optimization machine learning model may adjust the trim optimization plan to more closely target a workpiece yield. The manner in which such optimization may be done may include aspects of the systems and methods described in, for instance, U.S. Pat. Nos. 9,128,810, 8,688,259 and 9,008,824, incorporated by reference herein in their entirety.

The trim optimization machine learning model(s) may be expanded for use in managing workpiece and trim production goals of multiple workpiece processing lines in a facility. For instance, an additional input to the trim optimization machine learning model(s) may include the internal and/or external orders for multiple workpiece processing lines in a facility. The trim optimization machine learning model(s) can output recommended settings for a workpiece processing optimization system of one or more workpiece processing systems in a facility to optimize the production of workpieces and trim across the facility.

The trim optimization engine 1214 may output data to the model management computing device 108 or another suitable computing device (e.g., a cloud-based computing device in communication with the model management computing device 108) for training the one or more machine learning models suitable for outputting a trim optimization plan. In that regard, the model management computing device 108 may receive or request relevant historical data generated by the processing computing device 132, the data processing computing device 107, and/or the trim optimization computing device 106. For instance, the historical data may pertain to workpiece/trim sensor data generated by the processing computing device 132 (e.g., sensor data for a workpiece and/or trim from the sensor data processing engine 1114 (e.g., after any pre-processing), FRS object views, 2D and/or 3D models from the model generation engine 1116, temperature data. etc.), workpiece type, trim source, trim freshness level, workpiece thickness or size, raw workpiece supply/demand data from the workpiece utilization computing device 110, finished workpiece/trim demand data from the workpiece utilization computing device 110 including “internal orders” and “external orders”, or any other data for use in training machine learning models.

The model management computing device 108 may also receive or request data regarding first cutting assembly 120 machine settings (e.g., from the processing computing device 132) and the second cutting assembly 124 machine settings (e.g., from the processing computing device 132). The machine settings, including an initial setting and any adjusted or corrected settings corresponding to information in workpiece sensor data and/or order filling requirements (or any input data useful for the trim optimization machine learning model(s)), may be used to train one or more machine learning models to generate a trim optimization plan.

In some examples, the trim optimization machine learning model(s) may be trained using trim optimization score(s). For training, trim optimization score(s) may be correlated to incoming workpiece specifications (e.g., type, thickness, size, etc.), finished workpiece specifications (percentage within spec, yield data, etc.), first cutting assembly 120 initial and adjusted settings, second cutting assembly 124 initial and adjusted settings, external and/or internal orders requirements and achieved targets, trim source, trim freshness level, etc. For instance, if, based on a first trim optimization score for workpieces having first specifications, settings for a slicer and/or portioner of the first cutting assembly 120 are adjusted to generate a different level or fat content level of untreated trim, the slicer/portioner adjustments can be correlated to the trim optimization score(s) for a specific slicer/portioner configuration.

The component or machine setting adjustment data may be derived from operator input in response to a trim optimization score output and/or a trim optimization plan output from a machine learning model correlated to a score. For example, if an operator receives a trim optimization plan including a recommendation for component or machine setting adjustments (optionally with a score), the operator may accept the recommendation, reject the recommendation, and/or make manual adjustments based on the recommendation. The operator's input can be part of the training data.

Any suitable type of artificial intelligence may be used, including machine learning models that incorporate convolutional neural networks and/or computer vision and/or image segmentation, optionally incorporating deep learning techniques. In one example, the trim optimization plan machine learning model may be able to identify separate workpieces on the conveyance assembly 130 by segmenting or “cutting out” an object, feature, etc., in an image. The trim optimization plan machine learning model may incorporate the Segment Anything Model (SAM) available from Meta AI, FastSAM from Ultralytics, or another suitable image segmentation model using image segmentation techniques.

Any suitable technique may be used to train the machine learning models, including but not limited to one or more of gradient descent, data augmentation, hyperparameter tuning, and freezing/unfreezing of model architecture layers. In some examples, annotated, raw images are used as the training input. In some examples, one or more features derived from the images, including but not limited to versions of the images in a transformed color space, set of edges detected in the image, one or more statistical calculations regarding the overall content of the images, or other features derived from the images may be used instead of or in addition to the annotated raw images to train the machine learning models.

To support processing of the machine learning models, the trim optimization computing device 106 may also be configured as a local, high power or edge computing device separate from the processing computing device 132 (e.g., like the data processing computing device described in U.S. Provisional Patent No. 63/588,917).

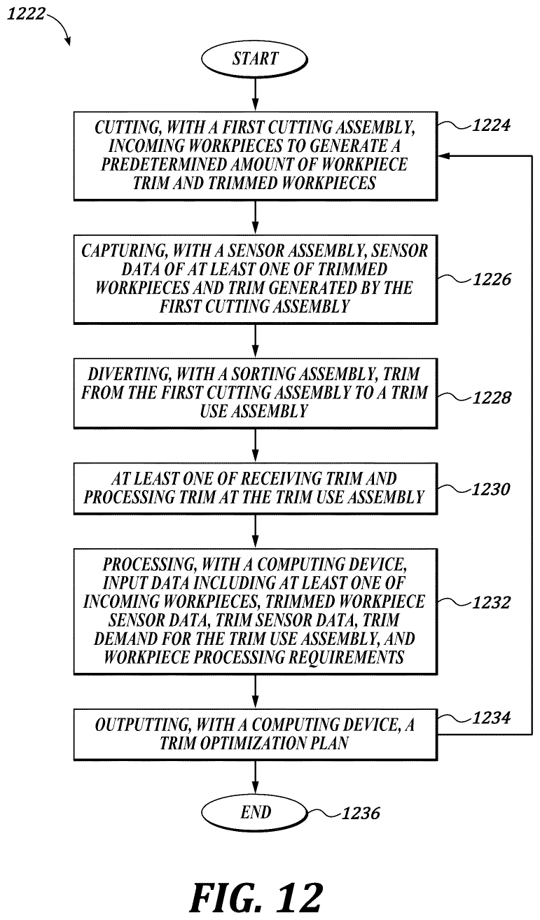

FIG. 12 is a flowchart of a non-limiting example of a method 1222 of managing aspects of workpiece processing, including optimizing trim production and use. The method 1222 may be carried out using any components described herein with reference to the workpiece processing optimization system 102, or any other suitable components. For ease of description, aspects of the method 1222 may be described with reference to the sensor assembly 116, the sorting assembly 118, the first cutting assembly 120, the treatment solution assembly 122, the second cutting assembly 124, the harvesting assembly 126, the secondary processing assembly 128, and the conveyance assembly 130, although aspects of the method should not be limited to such components. Moreover, aspects of the method 1222 may be carried out by the processing computing device 132, the trim optimization computing device 106, the data processing computing device 107, and/or any other suitable computing device.

From a start block, the method 1222 may proceed to block 1224, which includes cutting, such as with the first cutting assembly 120, incoming workpieces to generate an amount of workpiece trim and trimmed workpieces. For instance, at least one of a slicer and a portioner may be used to horizontally and/or vertically slice the incoming workpieces.

Before cutting at the first cutting assembly 120, the incoming workpieces may be scanned and/or weighed by a sensor assembly, such as a portion of sensor assembly 116. In that regard, the method may include capturing, with a sensor assembly, sensor data of incoming workpieces. The slicer and/or portioner may be adjusted, either manually or automatically (e.g., based on trim optimization plan instructions) to accommodate physical characteristics of the workpiece determined from the sensor data, such as height, thickness, fat content level, etc. In some examples, the sliced or portioned workpieces, before leaving the first cutting assembly 120, may pass a portion of the sensor assembly 116 (e.g., an optical scanner) to assess physical characteristics of the sliced or portioned workpieces before performing the other of slicing or portioning. The method may also include sorting, with a sorting assembly, incoming workpieces having a first physical characteristic to a first portion of a first cutting assembly (e.g., a first lane, slicer, or portioner) and workpieces having a second physical characteristic to a second portion of the first cutting assembly (e.g., a second lane, slicer, or portioner) to generate at least one of a target amount/type of trim and a target size of sliced/portioned workpieces (or simply “trimmed workpieces”) from each of the first and second portions of the first cutting assembly. The incoming workpieces may be sorted, such as into first and second lanes, according to first and second finished workpiece specifications, incoming or raw workpiece supply, target trim fat content, etc.

The method may proceed to block 1226, which includes capturing, with a sensor assembly, sensor data of at least one of trimmed workpieces and trim generated by the first cutting assembly 120. For instance, the trimmed workpieces and trim may pass by a portion of sensor assembly 116, such as an optical scanner, to generate image data for identifying workpieces and trim. The trimmed workpieces and trim may also or instead pass by a weigh station configured to capture a weight of some or all of the trimmed workpieces and trim. The trimmed workpieces and trim may also or instead pass by a temperature sensor configured to capture a temperature of some or all of the trimmed workpieces and trim.

The method may proceed to block 1228, which includes diverting, with a sorting assembly, trim from the first cutting assembly to a trim use assembly. For instance, the method may include sorting, such as with the sorting assembly 118, the sliced and/or portioned workpieces from trim generated during the slicing and/or portioning at the first cutting assembly 120. The sorting assembly 118 may use the sensor data of the trimmed workpieces and/or trim for identifying the trimmed workpieces and/or trim to carry out the required sorting.

The method may proceed to block 1230, which includes at least one of receiving trim and processing trim at the trim use assembly. The trim use assembly May include a treatment solution assembly, such as treatment solution assembly 122. In that regard, the method may include producing, with a treatment solution assembly, a treatment solution using the workpiece trim, and applying, with the treatment solution assembly, the treatment solution to trimmed workpieces. The treatment solution may be applied to the trimmed workpieces by injection or other suitable means. Moreover, the treatment solution may be applied to trimmed workpieces of the same clean break production run as the workpieces used to generate the workpiece trim.

The method may proceed to block 1232, which includes processing, with a computing device, input data including at least one of incoming workpiece sensor data, workpiece supply data (e.g., from the demand engine 134 of the workpiece utilization computing device 110), trimmed workpiece sensor data, trim sensor data, trim demand for the trim use assembly, and workpiece processing requirements. The input data may include trim source, trim freshness level, trim fat content, order filling requirements of finished workpieces (“external orders”) and untreated trim (“internal orders”), workpiece type (e.g., chicken breast fillets v. butterflies), workpiece thickness or size, workpiece processing specifications such as workpiece processing system requirements (e.g., slicer configurations, portioner settings, injector settings, etc.), temperature data, etc.

The method may proceed to block 1234, which includes outputting, with a computing device, a trim optimization plan. The trim optimization plan may include at least one of a trim designation location in the trim use assembly for an amount of trim (e.g., the treatment solution assembly 122 or the secondary processing assembly 128) and instructions for adjusting settings of the first cutting assembly 120 to change an amount of workpiece trim generated by the first cutting assembly. For instance, if trim demand is high, the trim optimization plan may include instructions to slice and/or portion more of a certain type of workpiece (e.g., workpieces of a certain thickness, fat content, etc.) at the first cutting assembly 120.

In some examples, the method includes at least one of cutting, trimming, and portioning (collectively “portioning”) the trimmed workpieces with a second cutting assembly, such as with second cutting assembly 124. Before proceeding to the second cutting assembly 124, the trimmed workpieces may pass a portion of sensor assembly 116, such as an X-ray and/or optical scanner, to assess one or more physical characteristics of the trimmed workpieces for determining a cut path for each workpiece based on finished workpiece requirements. In some examples, the method includes adjusting, based on sensor data of trimmed workpieces, settings of a slicer and/or portioner of the first cutting assembly 120.

In some examples, the method includes performing, with a secondary processing assembly, such as secondary processing assembly 128 at least one secondary processing step on the portioned workpieces. The secondary processing may include horizontally slicing, with a slicer, trimmed workpieces having a first thickness and at least one of breading, thermal processing, and packaging portioned workpieces having a second thickness less than the first thickness with a breader, thermal processor, and packager, respectively.

In some examples, the method includes determining, with a computing device, if the amount and/or type of workpiece trim generated by the first cutting assembly 120 is sufficient to produce a treatment solution at the treatment solution assembly 122. In that regard, the method may further include providing instructions, with a computing device, for generating more trim at the first cutting assembly if the amount of workpiece trim generated by the first cutting assembly is insufficient to produce a treatment solution at the treatment solution assembly and/or providing instructions, with a computing device, to divert a portion of an untrimmed incoming supply of workpieces with the sorting assembly 118 to the treatment solution assembly 122 for use in producing a treatment solution.

In some examples, the method includes designating a workpiece having a first thickness for horizontal slicing at the first cutting assembly 120 to generate an increased amount of workpiece trim and/or designating a workpiece having a first shape or size for vertical cutting at the first cutting assembly 120 to generate an increased amount of workpiece trim. The designated workpieces may be selected, at least in part, based on a finished workpiece demand of the designated workpiece (e.g., based on information received from the workpiece utilization computing device 110).

In some examples, the method includes determining, with a computing device, if the amount of workpiece trim generated by the first cutting assembly 120 exceeds an amount needed to produce a treatment solution at the treatment solution assembly 122. In that regard, the method may further include providing instructions, with a computing device, for generating less trim at the first cutting assembly 120 and providing instructions, with a computing device, to the sorting assembly 118 to divert a portion of workpiece trim to a secondary processing assembly, such as a portion of secondary processing assembly 128. The instructions may include at least one of designating a workpiece having a first thickness for horizontal slicing at the first cutting assembly to generate a decreased amount of workpiece trim and designating a workpiece having a first shape or size for vertical cutting at the first cutting assembly to generate a decreased amount of workpiece trim. The designated workpieces may be selected, at least in part, based on a finished workpiece demand of the designated workpiece (e.g., based on information received from the workpiece utilization computing device 110).

The method may further include providing instructions, with a computing device, for generating trim having a different fat content level at the first cutting assembly 120 if the fat content level of the workpiece trim generated by the first cutting assembly is insufficient to produce a treatment solution at the treatment solution assembly. In some examples, the method includes designating a workpiece having a first fat content level for horizontal slicing at the first cutting assembly 120 to generate an increased amount of workpiece trim having a higher or lower fat content and/or designating a workpiece having a first fat content level for vertical cutting at the first cutting assembly 120 to generate an increased amount of workpiece trim having a higher or lower fat content.

The method 1222 may proceed to an end block 1236, or the method 1222 may be repeated as necessary, such as for continuously managing aspects of workpiece processing, including optimizing trim production and use. For instance, the method 1222 may be repeated on timed intervals during an entire production run to continue to adjust processing aspects of the workpiece processing system 104 for optimizing trim production and use.

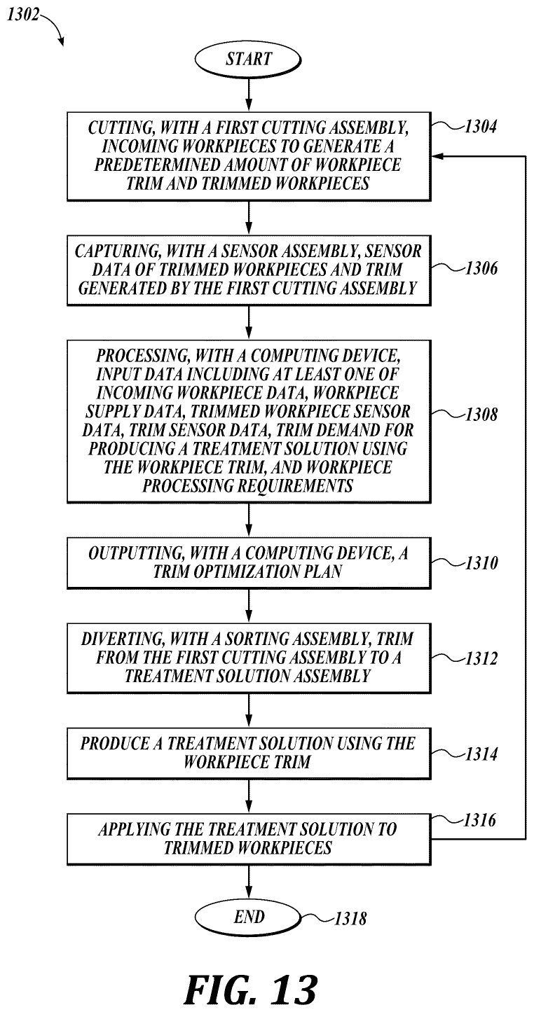

FIG. 13 is a flowchart of a non-limiting example of a method 1302 of treating workpieces with a treatment solution. The method 1302 may be carried out using any components described herein with reference to the workpiece processing optimization system 102, or any other suitable components. For ease of description, aspects of the method 1302 may be described with reference to the sensor assembly 116, the sorting assembly 118, the first cutting assembly 120, the treatment solution assembly 122, the second cutting assembly 124, the harvesting assembly 126, the secondary processing assembly 128, and the conveyance assembly 130, although aspects of the method should not be limited to such components. Moreover, aspects of the method 1302 may be carried out by the processing computing device 132, the trim optimization computing device 106, the data processing computing device 107, and/or any other suitable computing device. Moreover, the method 1302 may incorporate any of the steps described above with respect to method 1222. Thus, certain aspects of method 1302 will not be described in detail.

From a start block, the method 1302 may proceed to block 1304, which includes cutting, such as with the first cutting assembly 120, incoming workpieces to generate an amount of workpiece trim and trimmed workpieces. For instance, at least one of a slicer and a portioner may be used to horizontally and/or vertically slice the incoming workpieces.

The method may proceed to block 1306, which includes capturing, with a sensor assembly, sensor data of at least one of trimmed workpieces and trim generated by the first cutting assembly. For instance, the trimmed workpieces and/or trim may pass by a portion of sensor assembly 116, such as an optical scanner, to generate image data for identifying workpieces and trim. The trimmed workpieces and/or trim may also or instead be weighed by a weigh station. A temperature of the trimmed workpieces and/or trim may also or instead be captured by a temperature sensor.

Before cutting at the first cutting assembly 120, the incoming workpieces may be scanned and/or weighed and/or measured in temperature by a sensor assembly, such as by a portion of sensor assembly 116. The slicer and/or portioner may be adjusted to accommodate physical characteristics of the workpiece determined from the sensor data, such as height, thickness, and fat content. Moreover, the incoming workpieces may be sorted, such as into first and second lanes, according to workpiece sensor data, first and second finished workpiece specifications, trim demand requirements (e.g., trim amount, trim fat level, etc.), etc.

The method may proceed to block 1308, which includes processing, with a computing device, input data including at least one of incoming workpiece sensor data, workpiece supply data (e.g., from the demand engine 134 of the workpiece utilization computing device 110), trimmed workpiece sensor data, trim sensor data, trim demand and/or fat level content for producing a treatment solution using the workpiece trim, and workpiece processing requirements. Input data may also include trim source, trim freshness level, order filling requirements of finished workpieces (“external orders”) and untreated trim (“internal orders”), workpiece type (e.g., chicken breast fillets v. butterflies), workpiece thickness or size, etc.

The method may then further include outputting, with a computing device, a trim optimization plan. The trim optimization plan may include instructions for adjusting settings of the first cutting assembly 120 to change the amount of workpiece trim generated by the first cutting assembly. For instance, if trim demand is high, the trim optimization plan may include instructions to slice and/or portion more of a certain type of workpiece (e.g., workpieces of a certain thickness) at the first cutting assembly 120. The trim optimization plan may also or instead include instructions for the first cutting assembly 120 to slice and/or portion more of a certain type of workpiece having a certain fat content and/or cut the workpieces in a certain manner to generate trim having a desired level of fat content.

The method may proceed to block 1310, which includes diverting, such as with sorting assembly 118, trim from the first cutting assembly 120 to a treatment solution assembly, such as treatment solution assembly 122. The method may then proceed to block 1314, which includes producing a treatment solution using the workpiece trim. The treatment solution may be produced at a first portion of the treatment solution assembly 122, such as a treatment solution formulation portion. The method may then proceed to block 1316, which includes applying the treatment solution to trimmed workpieces. The treatment solution may be applied at a second portion of the treatment solution assembly 122, such as a treatment solution application portion.

The treated workpieces may then be further processed in any suitable manner, such as in the manner described above with respect to method 1222.

The method 1302 may proceed to an end block, or the method 1302 may be repeated as necessary, such as for continuously treating workpieces for an entire production run.

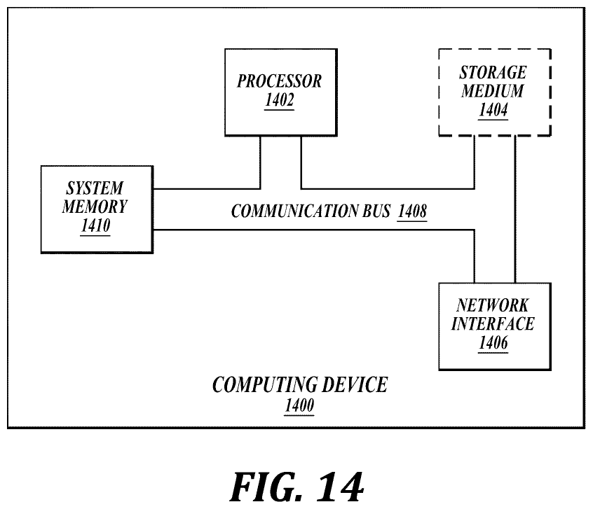

FIG. 14 is a block diagram that illustrates aspects of an exemplary computing device 1400 appropriate for use as a computing device of the present disclosure. While multiple different types of computing devices were discussed above, the exemplary computing device 1400 describes various elements that are common to many different types of computing devices. While FIG. 14 is described with reference to a computing device that is implemented as a device on a network, the description below is applicable to servers, personal computers, mobile phones, smart phones, tablet computers, embedded computing devices, and other devices that may be used to implement portions of examples of the present disclosure. Some examples of a computing device may be implemented in or may include an application-specific integrated circuit (ASIC), a field-programmable gate array (FPGA), or other customized device. Moreover, those of ordinary skill in the art and others will recognize that the computing device 1400 may be any one of any number of currently available or yet to be developed devices.

In its most basic configuration, the computing device 1400 includes at least one processor 1402 and a system memory 1410 connected by a communication bus 1408. Depending on the exact configuration and type of device, the system memory 1410 may be volatile or nonvolatile memory, such as read only memory (“ROM”), random access memory (“RAM”), EEPROM, flash memory, or similar memory technology. Those of ordinary skill in the art and others will recognize that system memory 1410 typically stores data and/or program modules that are immediately accessible to and/or currently being operated on by the processor 1402. In this regard, the processor 1402 may serve as a computational center of the computing device 1400 by supporting the execution of instructions.

As further illustrated in FIG. 14, the computing device 1400 may include a network interface 1406 comprising one or more components for communicating with other devices over a network. Examples of the present disclosure may access basic services that utilize the network interface 1406 to perform communications using common network protocols. The network interface 1406 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 1406 illustrated in FIG. 14 may represent one or more wireless interfaces or physical communication interfaces described and illustrated above with respect to particular components of the computing device 1400.

In the example depicted in FIG. 14, the computing device 1400 also includes a storage medium 1404. However, services may be accessed using a computing device that does not include means for persisting data to a local storage medium. Therefore, the storage medium 1404 depicted in FIG. 14 is represented with a dashed line to indicate that the storage medium 1404 is optional. In any event, the storage medium 1404 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 1402, system memory 1410, communication bus 1408, storage medium 1404, and network interface 1406 are known and commercially available. For ease of illustration and because it is not important for an understanding of the claimed subject matter, FIG. 14 does not show some of the typical components of many computing devices. In this regard, the computing device 1400 may include input devices, such as a keyboard, keypad, mouse, microphone, touch input device, touch screen, tablet, and/or the like. Such input devices may be coupled to the computing device 1400 by wired or wireless connections including RF, infrared, serial, parallel, Bluetooth, Bluetooth low energy, USB, or other suitable connections protocols using wireless or physical connections. Similarly, the computing device 1400 may also include output devices such as a display, speakers, printer, etc. Since these devices are well known in the art, they are not illustrated or described further herein.

While the concepts of the present disclosure are susceptible to various modifications and alternative forms, specific examples thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one example,” “an example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “up”, “down”, “left”, “right”, “first”, “second”, etc., in the present disclosure is meant to provide orientation for the reader with reference to the drawings and is not intended to be the required orientation of the components or graphical images or to impart orientation limitations into the claims.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative FIGS. Additionally, the inclusion of a structural or method feature in a particular FIG. is not meant to imply that such feature is required in all examples and, in some examples, it may not be included or may be combined with other features.

The present application may include modifiers such as the words “generally,” “approximately,” “about”, or “substantially.” These terms are meant to serve as modifiers to indicate that, for instance, the “dimension,” “shape,” “temperature,” “time,” or other physical parameter in question need not be exact, but may vary as long as the function that is required to be performed can be carried out.

As used herein, the terms “about”, “approximately,” etc., in reference to a number, is used herein to include numbers that fall within a range of 10%, 5%, or 1% in either direction (greater than or less than) the number unless otherwise stated or otherwise evident from the context (except where such number would exceed 100% of a possible value).

Where electronic or software components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Headings of sections provided in this patent application and the title of this patent application are for convenience only and are not to be taken as limiting the disclosure in any way.

While preferred examples of the present invention have been shown and described herein, it will be apparent to those skilled in the art that such examples are provided by way of example only. Numerous variations, changes, and substitutions will now occur to those skilled in the art without departing from the invention. Various alternatives to the examples of the invention described herein may be employed in practicing the invention. It is intended that the following claims define the scope of the invention and that methods and structures within the scope of these claims and their equivalents be covered.

### LISTING OF INNOVATIONS

Clause 1. A workpiece processing optimization system, comprising: a first cutting assembly configured to generate workpiece trim and trimmed workpieces; a sensor assembly configured to generate at least one of trimmed workpiece sensor data and trim sensor data; a sorting assembly configured to divert trim from the first cutting assembly to a trim use assembly, the trim use assembly configured to perform at least one of receiving trim and processing trim; a processor; and a memory storing instructions that, when executed by the processor, cause a computing device of the workpiece processing optimization system to: process input data including at least one of trimmed workpiece sensor data, trim sensor data, trim demand for the trim use assembly, workpiece supply data, and workpiece processing requirements; and output a trim optimization plan including at least one of: a trim designation location in the trim use assembly for an amount of trim; instructions for adjusting settings of the first cutting assembly to change an amount of workpiece trim generated by the first cutting assembly.

Clause 2. The workpiece processing optimization system of Clause 1, wherein the trim optimization plan may include instructions for adjusting settings of the first cutting assembly to change a fat content level in workpiece trim generated by the first cutting assembly.

Clause 3. The workpiece processing optimization system of Clause 1, further comprising: a second cutting assembly configured to perform at least one of cutting, trimming, and portioning the trimmed workpieces; and a secondary processing assembly configured to perform at least one secondary processing step on the trimmed workpieces, the secondary processing assembly comprising: a slicer configured to horizontally slice trimmed workpieces having a first thickness; and at least one of a breader, thermal processor, and packager for at least one of correspondingly breading, thermal processing, and packaging trimmed workpieces having a second thickness less than the first thickness; and a movement assembly configured to move workpieces within the workpiece processing optimization system.

Clause 4. The workpiece processing optimization system of Clause 1 or 3, wherein the trim use assembly includes a treatment solution assembly configured to produce a treatment solution using the workpiece trim and apply the treatment solution to trimmed workpieces.

Clause 5. The workpiece processing optimization system of Clause 4, wherein the memory storing instructions that, when executed by the processor, further cause a computing device of the workpiece processing optimization system to: analyze at least one of workpiece and trim temperature data to determine whether trim temperature is above or below a target temperature for producing a treatment solution at the treatment solution assembly; and output instructions for adjusting one or more temperature control devices to change the temperature of the trim.

Clause 6. The workpiece processing optimization system of Clause 4 or 5, wherein the memory storing instructions that, when executed by the processor, further cause a computing device of the workpiece processing optimization system to: determine a fat content level of at least one of incoming workpieces and trim to determine; and output instructions for adjusting the fat content level of trim generated by the first cutting assembly.

Clause 7. The workpiece processing optimization system of Clause 6, wherein the instructions may include at least one of: adjusting a vertical cut path of at least some of the workpieces at the first cutting assembly; designating a workpiece having a first fat content level for horizontal slicing at a first slicing height and designating a workpiece having a second fat content level for horizontal slicing at a second slicing height.

Clause 8. The workpiece processing optimization system of Clause 4, wherein the memory storing instructions that, when executed by the processor, further cause a computing device of the workpiece processing optimization system to: determine if the amount of workpiece trim generated by the first cutting assembly is sufficient to produce a treatment solution at the treatment solution assembly; and at least one of: provide instructions for generating more trim at the first cutting assembly if the amount of workpiece trim generated by the first cutting assembly is insufficient to produce a treatment solution at the treatment solution assembly; and provide instructions to the sorting assembly to divert a portion of an untrimmed incoming supply of workpieces to the treatment solution assembly for use in producing a treatment solution.

Clause 9. The workpiece processing optimization system of Clause 8, wherein the instructions may include at least one of: designating a workpiece having a first thickness for horizontal slicing at the first cutting assembly to generate an increased amount of workpiece trim; and designating a workpiece having a first shape or size for vertical cutting at the first cutting assembly to generate an increased amount of workpiece trim, wherein the designated workpieces are selected, at least in part, based on a finished workpiece demand of the designated workpiece.

Clause 10. The workpiece processing optimization system of Clause 8 or 9, wherein the designated workpieces are selected, at least in part, based on at least one of a weighted value of finished workpiece thickness, a weighted value of finished workpiece weight, and a weighted value of excess trim.

Clause 11. The workpiece processing optimization system of Clause 8, 9, or 10, wherein the instructions may include slicer settings changes for slicing workpieces at a different slice height.

Clause 12. The workpiece processing optimization system of Clause 1, wherein the instructions for adjusting settings of the first cutting assembly are based on at least one of a weighted value of finished workpiece thickness, a weighted value of finished workpiece weight, and a weighted value of excess trim.

Clause 13. The workpiece processing optimization system of Clause 8, wherein the memory storing instructions that, when executed by the processor, further cause a computing device of the workpiece processing optimization system to: determine if the amount of workpiece trim generated by the first cutting assembly exceeds an amount needed to produce a treatment solution at the treatment solution assembly; and at least one of: provide instructions for generating less trim at the first cutting assembly; and provide instructions to the sorting assembly to divert a portion of workpiece trim to a secondary processing assembly.

Clause 14. The workpiece processing optimization system of Clause 13, wherein the instructions may include at least one of: designating a workpiece having a first thickness for horizontal slicing at the first cutting assembly to generate a decreased amount of workpiece trim; and designating a workpiece having a first shape or size for vertical cutting at the first cutting assembly to generate a decreased amount of workpiece trim, wherein the designated workpieces are selected, at least in part, based on a finished workpiece demand of the designated workpiece.

Clause 15. The workpiece processing optimization system of Clauses 1, 3, 4, 8, 13, or 14 wherein the first cutting assembly includes at least one of a slicer and a portioner configured to perform at least one of slicing and portioning a workpiece, respectively, to generate an amount of workpiece trim and trimmed workpieces.

Clause 16. The workpiece processing optimization system of Clause 15, wherein at least one of the slicer and the portioner may be configured to slice and portion workpieces, respectively, in first and second lanes according to first and second finished workpiece specifications.

Clause 17. The workpiece processing optimization system of Clause 16, wherein the trim use assembly includes a treatment solution assembly configured to produce a treatment solution using the workpiece trim and apply the treatment solution to trimmed workpieces.

Clause 18. The workpiece processing optimization system of Clause 17, further comprising: a second cutting assembly configured to portion workpieces that are trimmed by the first cutting assembly and treated by the treatment solution assembly; a secondary processing assembly configured to perform at least one secondary processing step on trimmed, treated, portioned workpieces, including at least one of sorting, slicing, packaging, breading, and thermal processing the trimmed, treated, portioned workpieces.

Clause 19. The workpiece processing optimization system of Clause 4, wherein the treatment solution assembly includes a top port needle carrier, comprising: a carrier upper section and a carrier lower section defining a feeder supply chamber therebetween that is in fluid communication with an inlet port; and a top port needle manifold plate assembly located between the carrier upper section and the carrier lower section, the top port needle manifold plate assembly defining a plurality of plate through-holes configured to substantially vertically align with top openings of a plurality of needles received in the carrier lower section, wherein the plate through-holes are shaped and sized to guide treatment solution having emulsified protein from the feeder supply chamber into the top openings of the plurality of needles without inducing substantial shear on the treatment solution.

Clause 20. The workpiece processing optimization system of Clause 4, wherein the plate openings are an inverted frusto-conical shape having a larger end opening opposite a smaller end opening, the smaller end opening configured to interface a top opening of a corresponding needle.

Clause 21. The treatment solution assembly of Clause 20, wherein the smaller end openings of each of the plate openings have a diameter of about 2 mm.

Clause 22. The treatment solution assembly of Clause 20 or 21, further comprising a curved edge defined at the larger end opening of each of the plate openings.

Clause 23. The treatment solution assembly of Clause 20 or 21, wherein the plate openings include a cylindrical portion extending from the smaller end opening having substantially the same inner diameter as an inner diameter of the top opening of the corresponding needle.

Clause 24. The treatment solution assembly of Clause 20, 21, 22, or 23, wherein the top port needle manifold plate assembly includes a bottom plate configured to vertically restrain the plurality of needles in a first direction and a top plate configured to vertically restrain the plurality of needles in a second, opposite direction, the plate openings defined in the top plate.

Clause 25. The treatment solution assembly of Clause 20, 21, 22, 23, or 24, wherein the treatment solution has a viscosity higher than water.

Clause 26. A workpiece processing system, comprising: a portion of a sensor assembly configured to generate incoming workpiece sensor data; a first cutting assembly configured to generate an amount of workpiece trim and trimmed workpieces; a portion of a sorting assembly configured to divert incoming workpieces having a first physical characteristic to a first portion of the first cutting assembly and workpieces having a second physical characteristic to a second portion of the first cutting assembly to generate at least one of a target amount of trim and a target size of trimmed workpieces from each of the first and second portions of the first cutting assembly; a portion of the sensor assembly configured to generate at least one of trimmed workpiece sensor data and trim sensor data; a portion of the sorting assembly configured to divert trim from the first cutting assembly to a trim use assembly, the trim use assembly configured to perform at least one of receiving trim and processing trim; and a first portion of a secondary processing assembly configured to perform at least one secondary processing step on the trimmed workpieces, including at least one of portioning the trimmed workpieces, sorting the trimmed workpieces, packaging the trimmed workpieces, slicing the trimmed workpieces, breading the trimmed workpieces, and thermally processing the trimmed workpieces; and a movement assembly configured to move workpieces.

Clause 27. The workpiece processing optimization system of Clause 26, further comprising: a second cutting assembly configured to perform at least one of cutting, trimming, and portioning the trimmed workpieces; and a portion of the secondary processing assembly configured to perform at least one secondary processing step on the trimmed workpieces, the secondary processing assembly comprising: a slicer configured to horizontally slice trimmed workpieces having a first thickness; and at least one of a breader, thermal processor, and packager for at least one of breading trimmed workpieces having a second thickness less than the first thickness.

Clause 28. The workpiece processing optimization system of Clause 26 or 27, further comprising: a processor; and a memory storing instructions that, when executed by the processor, cause a computing device of the workpiece processing optimization system to: process input data including at least one of trimmed workpiece sensor data, trim sensor data, trim demand for the trim use assembly, workpiece supply data, and workpiece processing requirements; and output a trim optimization plan including at least one of: a trim designation location in the trim use assembly for a predetermined amount of trim; and instructions for adjusting settings of the first cutting assembly to change the amount of workpiece trim generated by the first cutting assembly.

Clause 29. The workpiece processing optimization system of Clause 28, wherein the trim use assembly includes a treatment solution assembly configured to produce a treatment solution using the workpiece trim and apply the treatment solution to trimmed workpieces.

Clause 30. The workpiece processing optimization system of Clause 29, wherein the memory storing instructions that, when executed by the processor, further cause a computing device of the workpiece processing optimization system to: analyze at least one of workpiece and trim temperature data to determine whether trim temperature is above or below a target temperature for producing a treatment solution at the treatment solution assembly; and output instructions for adjusting one or more temperature control devices to change the temperature of the trim.

Clause 31. The workpiece processing optimization system of Clause 29, wherein the memory storing instructions that, when executed by the processor, further cause a computing device of the workpiece processing optimization system to: determine a fat content level of at least one of incoming workpieces and trim to determine; and output instructions for adjusting the fat content level of trim generated by the first cutting assembly.

Clause 32. The workpiece processing optimization system of Clause 31, wherein the instructions may include at least one of: adjusting a vertical cut path of at least some of the workpieces at the first cutting assembly; and designating a workpiece having a first fat content level for horizontal slicing at a first slicing height and designating a workpiece having a second fat content level for horizontal slicing at a second slicing height.

Clause 33. The workpiece processing optimization system of Clause 29, wherein the memory storing instructions that, when executed by the processor, further cause a computing device of the workpiece processing optimization system to: determine if the amount of workpiece trim generated by the first cutting assembly is sufficient to produce a treatment solution at the treatment solution assembly; and at least one of: provide instructions for generating more trim at the first cutting assembly if the amount of workpiece trim generated by the first cutting assembly is insufficient to produce a treatment solution at the treatment solution assembly; and provide instructions to the sorting assembly to divert a portion of an untrimmed incoming supply of workpieces to the treatment solution assembly for use in producing a treatment solution.

Clause 34. The workpiece processing optimization system of Clause 33, wherein the instructions include at least one of: designating a workpiece having a first thickness for horizontal slicing at the first cutting assembly to generate an increased amount of workpiece trim; and designating a workpiece having a first shape or size for vertical cutting at the first cutting assembly to generate an increased amount of workpiece trim, wherein the designated workpieces are selected, at least in part, based on a finished workpiece demand of the designated workpiece.

Clause 35. The workpiece processing optimization system of Clause 26, 28, 29, 33, or 34, wherein the memory storing instructions that, when executed by the processor, further cause a computing device of the workpiece processing optimization system to: determine if the amount of workpiece trim generated by the first cutting assembly exceeds an amount needed to produce a treatment solution at the treatment solution assembly; and at least one of: provide instructions for generating less trim at the first cutting assembly; and provide instructions to the sorting assembly to divert a portion of workpiece trim to a secondary processing assembly.

Clause 36. The workpiece processing optimization system of Clause 34, wherein the instructions include at least one of: designating a workpiece having a first thickness for horizontal slicing at the first cutting assembly to generate a decreased amount of workpiece trim; and designating a workpiece having a first shape or size for vertical cutting at the first cutting assembly to generate a decreased amount of workpiece trim, wherein the designated workpieces are selected, at least in part, based on a finished workpiece demand of the designated workpiece.

Clause 37. The workpiece processing optimization system of Clauses 29, 33, 34, 35, or 36 wherein the first cutting assembly includes at least one of a slicer and a portioner configured to perform at least one of slicing and portioning a workpiece, respectively, to generate an amount of workpiece trim and trimmed workpieces.

Clause 38. The workpiece processing optimization system of Clause 37, wherein at least one of the slicer and the portioner may be configured to slice and portion workpieces, respectively, in first and second lanes according to first and second finished workpiece specifications.

Clause 39. The workpiece processing optimization system of Clause 29, 33, 34, 35, 36, 37, or 38, further comprising: a second cutting assembly configured to portion workpieces that are trimmed by the first cutting assembly and treated by the treatment solution assembly; and a portion of the secondary processing assembly configured to perform at least one secondary processing step on trimmed, treated, portioned workpieces, including at least one of sorting, slicing, packaging, breading, and thermal processing the trimmed, treated, portioned workpieces.

Clause 40. The workpiece processing optimization system of Clause 29, wherein the treatment solution assembly includes a top port needle carrier, comprising: a carrier upper section and a carrier lower section defining a feeder supply chamber therebetween that is in fluid communication with an inlet port; and a top port needle manifold plate assembly located between the carrier upper section and the carrier lower section, the top port needle manifold plate assembly defining a plurality of plate through-holes configured to substantially vertically align with top openings of a plurality of needles received in the carrier lower section, wherein the plate through-holes are shaped and sized to guide treatment solution having emulsified protein from the feeder supply chamber into the top openings of the plurality of needles without inducing substantial shear on the treatment solution.

Clause 41. The workpiece processing optimization system of Clause 40, wherein the plate openings are an inverted frusto-conical shape having a larger end opening opposite a smaller end opening, the smaller end opening configured to interface a top opening of a corresponding needle.

Clause 42. The treatment solution assembly of Clause 41, wherein the smaller end openings of each of the plate openings have a diameter of about 2 mm.

Clause 43. The treatment solution assembly of Clause 41 or 42, further comprising a curved edge defined at the larger end opening of each of the plate openings.

Clause 44. The treatment solution assembly of Clause 41 or 42, wherein the plate openings include a cylindrical portion extending from the smaller end opening having substantially the same inner diameter as an inner diameter of the top opening of the corresponding needle.

Clause 45. The treatment solution assembly of Clause 41, 42, 43, or 44, wherein the top port needle manifold plate assembly includes a bottom plate configured to vertically restrain the plurality of needles in a first direction and a top plate configured to vertically restrain the plurality of needles in a second, opposite direction, the plate openings defined in the top plate.

Clause 46. The treatment solution assembly of Clause 41, 42, 43, 44, or 45, wherein the treatment solution has a viscosity higher than water.

Clause 47. A method of optimizing trim for a workpiece processing system, comprising: cutting, with a first cutting assembly, incoming workpieces to generate an amount of workpiece trim and trimmed workpieces; capturing, with a sensor assembly, sensor data of at least one of incoming workpieces, trimmed workpieces, and trim; diverting, with a sorting assembly, trim from the first cutting assembly to a trim use assembly; at least one of receiving trim and processing trim at the trim use assembly; processing, with a computing device, input data including at least one of incoming workpieces, trimmed workpiece sensor data, trim sensor data, trim demand for the trim use assembly, and workpiece processing requirements; and outputting, with a computing device, a trim optimization plan including at least one of: a trim designation location in the trim use assembly for an amount of trim; and instructions for adjusting settings of the first cutting assembly to change the amount of workpiece trim generated by the first cutting assembly.

Clause 48. The method of Clause 47, further comprising sorting, with a sorting assembly, incoming workpieces having a first physical characteristic to a first portion of the first cutting assembly and workpieces having a second physical characteristic to a second portion of the first cutting assembly to generate at least one of a target amount of trim and a target size of trimmed workpieces from each of the first and second portions of the first cutting assembly.

Clause 49. The method of Clause 47, further comprising: portioning the trimmed workpieces with a second cutting assembly; and performing, with a secondary processing assembly, at least one secondary processing step on the portioned workpieces, including: horizontally slicing, with a slicer, portioned workpieces having a first thickness; and at least one of breading, thermal processing, and packaging portioned workpieces having a second thickness less than the first thickness with a breader, thermal processor, and packager, respectively.

Clause 50. The method of Clause 47, 48, or 49, further comprising: producing, with a treatment solution assembly, a treatment solution using the workpiece trim; and applying, with the treatment solution assembly, the treatment solution to trimmed workpieces.

Clause 51. The method of Clause 47, 48, or 49, further comprising: determining, with a computing device, if the amount of workpiece trim generated by the first cutting assembly is sufficient to produce a treatment solution at the treatment solution assembly; and at least one of: providing instructions, with a computing device, for generating more trim at the first cutting assembly if the amount of workpiece trim generated by the first cutting assembly is insufficient to produce a treatment solution at the treatment solution assembly; and providing instructions, with a computing device, to the sorting assembly to divert a portion of an untrimmed incoming supply of workpieces to the treatment solution assembly for use in producing a treatment solution.

Clause 52. The method of Clause 51, wherein the instructions may include at least one of: designating a workpiece having a first thickness for horizontal slicing at the first cutting assembly to generate an increased amount of workpiece trim; and designating a workpiece having a first shape or size for vertical cutting at the first cutting assembly to generate an increased amount of workpiece trim, wherein the designated workpieces are selected, at least in part, based on a finished workpiece demand of the designated workpiece.

Clause 53. The method of Clause 51 or 52, further comprising: determining, with a computing device, if the amount of workpiece trim generated by the first cutting assembly exceeds an amount needed to produce a treatment solution at the treatment solution assembly; and at least one of: providing instructions, with a computing device, for generating less trim at the first cutting assembly; and providing instructions, with a computing device, to the sorting assembly to divert a portion of workpiece trim to a secondary processing assembly.

Clause 54. The method of Clause 53, wherein the instructions may include at least one of: designating a workpiece having a first thickness for horizontal slicing at the first cutting assembly to generate a decreased amount of workpiece trim; and designating a workpiece having a first shape or size for vertical cutting at the first cutting assembly to generate a decreased amount of workpiece trim, wherein the designated workpieces are selected, at least in part, based on a finished workpiece demand of the designated workpiece.

Clause 55. The method of Clauses 47, 48, 49, 50, 51, 52, 53, or 54, further comprising at least one of slicing and portioning a workpiece, at the first cutting assembly, to generate a predetermined amount of workpiece trim and trimmed workpieces.

Clause 56. The method of Clause 55, further comprising at least one of slicing and portioning a workpiece, at the first cutting assembly, in first and second lanes according to first and second finished workpiece specifications.

Clause 57. The method of Clause 56, further comprising: producing a treatment solution using the workpiece trim; and applying the treatment solution to trimmed workpieces.

Clause 58. The method of Clause 57, further comprising: portioning workpieces that are trimmed by the first cutting assembly and treated with the treatment solution; and performing at least one secondary processing step on trimmed, treated, portioned workpieces, including at least one of sorting, slicing, packaging, breading, and thermal processing the trimmed, treated, portioned workpieces.

Clause 59. The method of Clause 47, 48, 49, 50, 51, 52, 53, 54, 55, or 56, further comprising: producing a treatment solution using the workpiece trim; and applying the treatment solution to trimmed workpieces of a same clean break production run as the workpieces used to generate the workpiece trim.

Clause 60. A method of treating workpieces with a treatment solution, comprising: cutting, with a first cutting assembly, incoming workpieces to generate an amount of workpiece trim and trimmed workpieces; capturing, with a sensor assembly, sensor data of at least one of incoming workpieces, trimmed workpieces, and trim; processing, with a computing device, input data including at least one of incoming workpiece data, workpiece supply data, trimmed workpiece sensor data, trim sensor data, trim demand for producing a treatment solution using the workpiece trim, and workpiece processing requirements; outputting, with a computing device, a trim optimization plan including instructions for adjusting settings of the first cutting assembly to change the amount of workpiece trim generated by the first cutting assembly; diverting, with a sorting assembly, trim from the first cutting assembly to a treatment solution assembly; producing a treatment solution using the workpiece trim; and applying the treatment solution to trimmed workpieces.

Clause 61. The method of Clause 60, further comprising sorting, with the sorting assembly, incoming workpieces having a first physical characteristic to a first portion of the first cutting assembly and workpieces having a second physical characteristic to a second portion of the first cutting assembly to generate at least one of a target amount of trim, a target size of trimmed workpieces, and a target trim fat content level from each of the first and second portions of the first cutting assembly.

Clause 62. The method of Clause 60 or 61, further comprising: determining, with a computing device, if the amount of workpiece trim generated by the first cutting assembly is sufficient to produce a treatment solution at the treatment solution assembly; and at least one of: providing instructions, with a computing device, for generating more trim at the first cutting assembly if the amount of workpiece trim generated by the first cutting assembly is insufficient to produce a treatment solution at the treatment solution assembly; and providing instructions, with a computing device, to the sorting assembly to divert a portion of an untrimmed incoming supply of workpieces to the treatment solution assembly for use in producing a treatment solution.

Clause 63. The method of Clause 62, wherein the instructions may include at least one of: designating a workpiece having a first thickness for horizontal slicing at the first cutting assembly to generate an increased amount of workpiece trim; and designating a workpiece having a first shape or size for vertical cutting at the first cutting assembly to generate an increased amount of workpiece trim, wherein the designated workpieces are selected, at least in part, based on a finished workpiece demand of the designated workpiece.

Clause 64. The method of Clause 60, 61, or 62, further comprising: determining, with a computing device, if the amount of workpiece trim generated by the first cutting assembly exceeds an amount needed to produce a treatment solution at the treatment solution assembly; and at least one of: providing instructions, with a computing device, for generating less trim at the first cutting assembly; and providing instructions, with a computing device, to the sorting assembly to divert a portion of workpiece trim to a secondary processing assembly.

Clause 65. The method of Clause 64, wherein the instructions may include at least one of: designating a workpiece having a first thickness for horizontal slicing at the first cutting assembly to generate a decreased amount of workpiece trim; and designating a workpiece having a first shape or size for vertical cutting at the first cutting assembly to generate a decreased amount of workpiece trim, wherein the designated workpieces are selected, at least in part, based on a finished workpiece demand of the designated workpiece.

Clause 66. The method of Clauses 60, 61, 62, 63, 64, or 65, further comprising at least one of slicing and portioning a workpiece, at the first cutting assembly, to generate a predetermined amount of workpiece trim and trimmed workpieces.

Clause 67. The method of Clause 66, further comprising at least one of slicing and portioning a workpiece, at the first cutting assembly, in first and second lanes according to first and second finished workpiece specifications.

Clause 68. The method of Clause 60, 61, 62, 63, 64, 65, 66, or 67, further comprising applying the treatment solution to trimmed workpieces of a same clean break production run as the workpieces used to generate the workpiece trim.

Clause 69. The method of Clause 60, 61, 62, 63, 64, 65, 66, 67, or 68, further comprising: analyzing at least one of workpiece and trim temperature data to determine whether trim temperature is above or below a target temperature for producing a treatment solution at the treatment solution assembly; and outputting instructions for adjusting one or more temperature control devices to change the temperature of the trim.

Clause 70. The method of Clause 60, 61, 62, 63, 64, 65, 66, 67, 68, or 69, further comprising: determining a fat content level of at least one of incoming workpieces and trim to determine; and outputting instructions for adjusting the fat content level of trim generated by the first cutting assembly.

Clause 71. The method of Clause 70, wherein the instructions may include at least one of: adjusting a vertical cut path of at least some of the workpieces at the first cutting assembly; and designating a workpiece having a first fat content level for horizontal slicing at a first slicing height and designating a workpiece having a second fat content level for horizontal slicing at a second slicing height.

The embodiments of the invention in which an exclusive property or privilege is claimed are defined as follows:

1. A workpiece processing optimization system, comprising:
a first cutting assembly configured to generate workpiece trim and trimmed workpieces;
a sensor assembly configured to generate at least one of trimmed workpiece sensor data and trim sensor data;
a sorting assembly configured to divert trim from the first cutting assembly to a trim use assembly, the trim use assembly configured to perform at least one of receiving trim and processing trim;
a processor; and
a memory storing instructions that, when executed by the processor, cause a computing device of the workpiece processing optimization system to:
process input data including at least one of trimmed workpiece sensor data, trim sensor data, trim demand for the trim use assembly, workpiece supply data, and workpiece processing requirements; and
output a trim optimization plan including at least one of:
a trim designation location in the trim use assembly for an amount of trim;
instructions for adjusting settings of the first cutting assembly to change an amount of workpiece trim generated by the first cutting assembly.

2. The workpiece processing optimization system of claim 1, wherein the trim optimization plan may include instructions for adjusting settings of the first cutting assembly to change a fat content level in workpiece trim generated by the first cutting assembly.

3. The workpiece processing optimization system of claim 1, wherein the instructions for adjusting settings of the first cutting assembly are based on at least one of a weighted value of finished workpiece thickness, a weighted value of finished workpiece weight, and a weighted value of excess trim.

4. The workpiece processing optimization system of claim 1, wherein the trim use assembly includes a treatment solution assembly configured to produce a treatment solution using the workpiece trim and apply the treatment solution to trimmed workpieces.

5. The workpiece processing optimization system of claim 4, wherein the memory storing instructions that, when executed by the processor, further cause a computing device of the workpiece processing optimization system to:
analyze at least one of workpiece and trim temperature data to determine whether trim temperature is above or below a target temperature for producing a treatment solution at the treatment solution assembly; and
output instructions for adjusting one or more temperature control devices to change the temperature of the trim.

6. The workpiece processing optimization system of claim 4, wherein the memory storing instructions that, when executed by the processor, further cause a computing device of the workpiece processing optimization system to:
determine a fat content level of at least one of incoming workpieces and trim; and
output instructions for adjusting the fat content level of trim generated by the first cutting assembly.

7. The workpiece processing optimization system of claim 6, wherein the instructions may include at least one of:
adjusting a vertical cut path of at least some of the workpieces at the first cutting assembly;
designating a workpiece having a first fat content level for horizontal slicing at a first slicing height and designating a workpiece having a second fat content level for horizontal slicing at a second slicing height.

8. The workpiece processing optimization system of claim 4, wherein the memory storing instructions that, when executed by the processor, further cause a computing device of the workpiece processing optimization system to:
determine if the amount of workpiece trim generated by the first cutting assembly is sufficient to produce a treatment solution at the treatment solution assembly; and
at least one of:
provide instructions for generating more trim at the first cutting assembly if the amount of workpiece trim generated by the first cutting assembly is insufficient to produce a treatment solution at the treatment solution assembly; and
provide instructions to the sorting assembly to divert a portion of an untrimmed incoming supply of workpieces to the treatment solution assembly for use in producing a treatment solution.

9. The workpiece processing optimization system of claim 8, wherein the instructions may include at least one of:
designating a workpiece having a first thickness for horizontal slicing at the first cutting assembly to generate an increased amount of workpiece trim; and
designating a workpiece having a first shape or size for vertical cutting at the first cutting assembly to generate an increased amount of workpiece trim, wherein the designated workpieces are selected, at least in part, based on a finished workpiece demand of the designated workpiece.

10. The workpiece processing optimization system of claim 8, wherein the memory storing instructions that, when executed by the processor, further cause a computing device of the workpiece processing optimization system to:
determine if the amount of workpiece trim generated by the first cutting assembly exceeds an amount needed to produce a treatment solution at the treatment solution assembly; and
at least one of:
provide instructions for generating less trim at the first cutting assembly; and
provide instructions to the sorting assembly to divert a portion of workpiece trim to a secondary processing assembly.

11. The workpiece processing optimization system of claim 10, wherein the instructions may include at least one of:
designating a workpiece having a first thickness for horizontal slicing at the first cutting assembly to generate a decreased amount of workpiece trim; and
designating a workpiece having a first shape or size for vertical cutting at the first cutting assembly to generate a decreased amount of workpiece trim,
wherein the designated workpieces are selected, at least in part, based on a finished workpiece demand of the designated workpiece.

12. The workpiece processing optimization system of claims 1, wherein the first cutting assembly includes at least one of a slicer and a portioner configured to perform at least one of slicing and portioning a workpiece, respectively, to generate an amount of workpiece trim and trimmed workpieces.

13. The workpiece processing optimization system of claim 12, wherein at least one of the slicer and the portioner may be configured to slice and portion workpieces, respectively, in first and second lanes according to first and second finished workpiece specifications.

14. The workpiece processing optimization system of claim 13, wherein the trim use assembly includes a treatment solution assembly configured to produce a treatment solution using the workpiece trim and apply the treatment solution to trimmed workpieces.

15. The workpiece processing optimization system of claim 14, further comprising:
a second cutting assembly configured to portion workpieces that are trimmed by the first cutting assembly and treated by the treatment solution assembly;
a secondary processing assembly configured to perform at least one secondary processing step on trimmed, treated, portioned workpieces, including at least one of sorting, slicing, packaging, breading, and thermal processing the trimmed, treated, portioned workpieces.

16. A workpiece processing system, comprising:
a portion of a sensor assembly configured to generate incoming workpiece sensor data;
a first cutting assembly configured to generate an amount of workpiece trim and trimmed workpieces;
a portion of a sorting assembly configured to divert incoming workpieces having a first physical characteristic to a first portion of the first cutting assembly and workpieces having a second physical characteristic to a second portion of the first cutting assembly to generate at least one of a target amount of trim and a target size of trimmed workpieces from each of the first and second portions of the first cutting assembly;
a portion of the sensor assembly configured to generate at least one of trimmed workpiece sensor data and trim sensor data;
a portion of the sorting assembly configured to divert trim from the first cutting assembly to a trim use assembly, the trim use assembly configured to perform at least one of receiving trim and processing trim; and
a first portion of a secondary processing assembly configured to perform at least one secondary processing step on the trimmed workpieces, including at least one of portioning the trimmed workpieces, sorting the trimmed workpieces, packaging the trimmed workpieces, slicing the trimmed workpieces, breading the trimmed workpieces, and thermally processing the trimmed workpieces; and
a movement assembly configured to move workpieces.

17. The workpiece processing optimization system of claim 16, further comprising:
a processor; and
a memory storing instructions that, when executed by the processor, cause a computing device of the workpiece processing optimization system to:
process input data including at least one of trimmed workpiece sensor data, trim sensor data, trim demand for the trim use assembly, workpiece supply data, and workpiece processing requirements; and
output a trim optimization plan including at least one of:
a trim designation location in the trim use assembly for a predetermined amount of trim; and
instructions for adjusting settings of the first cutting assembly to change the amount of workpiece trim generated by the first cutting assembly.

18. A method of optimizing trim for a workpiece processing system, comprising:
cutting, with a first cutting assembly, incoming workpieces to generate an amount of workpiece trim and trimmed workpieces;
capturing, with a sensor assembly, sensor data of at least one of incoming workpieces, trimmed workpieces, and trim;
diverting, with a sorting assembly, trim from the first cutting assembly to a trim use assembly;
at least one of receiving trim and processing trim at the trim use assembly;
processing, with a computing device, input data including at least one of incoming workpieces, trimmed workpiece sensor data, trim sensor data, trim demand for the trim use assembly, and workpiece processing requirements; and
outputting, with a computing device, a trim optimization plan including at least one of:
a trim designation location in the trim use assembly for an amount of trim; and
instructions for adjusting settings of the first cutting assembly to change the amount of workpiece trim generated by the first cutting assembly.

19. The method of claim 18, further comprising sorting, with a sorting assembly, incoming workpieces having a first physical characteristic to a first portion of the first cutting assembly and workpieces having a second physical characteristic to a second portion of the first cutting assembly to generate at least one of a target amount of trim and a target size of trimmed workpieces from each of the first and second portions of the first cutting assembly.

20. The method of claim 18, further comprising:
producing a treatment solution using the workpiece trim; and
applying the treatment solution to trimmed workpieces of a same clean break production run as the workpieces used to generate the workpiece trim.
